(19) United States
(12) Patent Application Publication
(10) Pub. No.: US 2007/0275357 A1
(43) Pub. Date: Nov. 29, 2007

(54) ELECTRONIC LEARNING AID FOR TEACHING ARITHMETIC SKILLS

(76) Inventor: Charles P. Resor, Wilson, WY (US)

Correspondence Address: HUSCH & EPPENBERGER, LLC, 190 CARONDELET PLAZA, SUITE 600, ST. LOUIS, MO, 63105-3441, US

(21) Appl. No.: 11/834,854

(22) Filed: Aug. 7, 2007

Related U.S. Application Data
(62) Division of application No. 10/083,455, filed on Feb. 26, 2002.

(51) Int. Cl. G09B 7/02

(52) U.S. Cl. 434/201

(57) ABSTRACT

An electronic learning aid for teaching arithmetic skills includes a question engine for selecting and communicating to a user a plurality of questions, one question at a time. The aid has a manually operable input device for use by the user to respond to the questions, and the question engine has at least one mode in which the engine ceases accepting a response to a question upon the entry of an incorrect alphanumeric character. The question engine, in response to the entry of an incorrect alphanumeric character, displays a subsequent question and waits for a predetermined period of time after display of the subsequent question before accepting a response to the subsequent question.

### CROSS-REFERENCES TO RELATED APPLICATIONS

This application is a divisional patent application and claims the benefit of pending U.S. Ser. No. 10/083,455, filed Feb. 26, 2002, which is herein incorporated by reference.

### STATEMENT REGARDING FEDERALLY SPONSORED RESEARCH OR DEVELOPMENT

Not applicable.

### BACKGROUND OF THE INVENTION

1. Field of the Invention

This invention relates to electronic learning aids for teaching arithmetic skills, specifically to such learning aids having problem-selection and user-performance-evaluation-communication features.

2. Prior Art

There are a number of electronic learning aids for teaching arithmetic skills that have been either manufactured or described. For instance: Texas Instruments, Incorporated, of Dallas, Tex., has marketed at least two such devices under the trademarks “Little Professor” and “Math . . . To Go!”; Radio Shack, a division of RadioShack Corporation of Ft. Worth, Tex., has marketed at least one such device under the mark “Talking Math Calculator”; and Educational Insights of Carson, Calif., has marketed at least three such devices under the trademarks: “Skillmaster”, “Drillmaster” and “MathShark”. Finally, Exploratoy has marketed one such device under the trademark “math whiz”. Examples of patents that describe such devices are: U.S. Pat. No. 4,321,046, issued Mar. 23, 1982 to Oda; U.S. Pat. No. 4,337,047, issued Jun. 29, 1982 to Hatta; U.S. Pat. No. 4,340,374, issued Jul. 20, 1982 to Culley; U.S. Pat. No. 4,340,375, issued Jul. 20, 1982 to Sakaue; U.S. Pat. No. 4,358,273, issued Nov. 9, 1982 to Yamamoto; U.S. Pat. No. 4,447,213 issued May 8, 1984 to Culley; and U.S. Pat. No. 4,611,996, issued Sep. 16, 1986 to Stoner. All of these devices display arithmetic problems, accept key-communicated answers to the problems, and, either immediately or subsequently, communicate information evaluating those answers. Each of these devices incorporates various other features asserted to achieve improved educational efficacy and, in some cases, improved entertainment value.

While the above devices provide a wide variety of features, none of them meets more than the first two of the following four minimal requisites for successful and widespread use by young elementary-school children, namely: (1) affordability, i.e., being sufficiently affordable for each student to have one exclusively available to such student when the class is using them, even if only fundamental arithmetic skills are taught; (2) portability, i.e., being light and compact enough to be easily transportable by young elementary school children between school and home and within the home; (3) problem-selection efficiency, i.e., being capable of sufficiently reducing the amount of time wasted answering inappropriate questions; and (4) “supervisability”, i.e., being capable of providing quickly and easily sufficient information about a child's prior unaccompanied use of such a device. While many of the prior-art devices have satisfied the affordability and portability requisites through the use of economical embedded integrated chip and liquid-crystal-display technologies, none of them has also adequately dealt with either the problem-selection efficiency requisite or the “supervisability” requisite.

It is also believed that prior art devices, to the extent that they have any limits on the amount of time during which an answer may be limited, do not take into account the fact that two or three digit answers may require a significantly longer period of time for entry.

In educational devices of this type, it is important that the child not be discouraged by what appears to be incorrect operation of the device. For example, this could arise where the child enters a two- or three-digit answer, one of the leading numerals of which is incorrect. The device, recognizing the answer as incorrect as soon as the first incorrect numeral is entered, will in many cases proceed to the next problem. If the child is slow enough in entering the preceding multi-digit incorrect answer, the device could interpret the response as two incorrect answers rather than just one. This result would be discouraging to the child, and would fail to accurately reflect the child's level of knowledge. Devices that allow such results could be improved.

3. Brief Summary of the Invention

The present invention provides an inexpensive electronic learning aid for teaching arithmetic skills that functions without an external source of electricity and is easily portable by young children. In the preferred embodiment it includes one or more of the following features:

(1) a question engine that selects and communicates to a user a plurality of questions, one question at a time;

(2) a question-probability-setting selector arranged to allow a user to select one of a plurality of question-probability settings, such that when a setting is in effect, everything else being equal: (a) each question has a predetermined probability of being the next question communicated, (b) the predetermined probability is equal to or greater than zero percent and less than or equal to one hundred percent, (c) the probability of a question with a probability greater than zero percent can differ from the probability of a different question with a probability greater than zero percent; and (d) the probability of a question with a probability greater than zero percent can differ from a greater-than-zero-percent probability of the same question when a different one of said settings is selected;

(3) an answer communicator (input device) for enabling the user to answer each question communicated by the question engine;

(4) a score generator for generating an evaluative score for a set of questions communicated by the question engine, the score being determined by how well the user answered the questions constituting the set;

(5) a score memory for storing a predetermined plurality of evaluative scores generated by the score generator and information relating to the scores, the score memory being arranged (a) to retain those scores and the related information even when the learning aid's main power is off and (b) to discontinue storing a score when necessary for storing a score for a more recent set of questions;

(6) a display for displaying visually one score at a time: each such score stored in the score memory along with stored information relating to that score;

(7) a missed-questions memory for storing a predetermined plurality of questions that, during any of a plurality of—scored and/or unscored—sets of questions, have been answered incorrectly or not answered within a per-question time limit, so that the question engine can, from the same group of missed questions stored in the memory, select and communicate to a user a plurality of—scored and/or unscored—sets of those questions, the missed-questions-memory being arranged (a) to retain those questions even when the learning aid's main power is off and (b) to discontinue storing a question when necessary for storing a more recently missed question;

(8) the question engine has at least one mode in which the time to respond to the questions has a per question limit, the question engine increasing the per question limit for those questions having a correct response that requires entry of two digits, and further increasing the per question limit for those questions having a correct response that requires entry of three digits; and

(9) the question engine in at least one mode detects the entry of an incorrect numeral, causes the display of a new problem in response to the entry of the incorrect numeral, and refuses to accept entry of a subsequent numeral until the new problem is displayed for at least a predetermined length of time.

Various embodiments of the present invention meet and provide one or more of the following objects and advantages:

An object of the present invention is to provide an improved electronic learning aid for teaching arithmetic skills.

A second object is to facilitate the efficient use of practice time by enabling a user—with respect to each of the four arithmetic operations—to select, as the source of problems to be presented, any one of a plurality of subsets or levels of problems such that each problem actually included in a particular subset or level has its own individual probability of being presented depending on the relative importance of the problem's being practiced in that particular subset or level.

A third object is to facilitate the efficient use of practice time by incorporating a missed-problems-practice feature which incorporates: (1) the ability to retain and, when desired, re-present up to a certain number of problems missed by the user in any one of a number of previous sets of problems; (2) the ability, even when the device is turned off, to retain those missed problems in memory for subsequent re-presenting; and (3) the ability, when the missed-problems memory is full, to continually make room for the problem missed most recently by eliminating from memory one missed previously.

A fourth object is to enable a teacher or parent to easily motivate a young elementary-school student to use the learning aid conscientiously even when not accompanied by the teacher or parent—by enabling the teacher or parent to thoroughly yet quickly check the performance of the student at a later, convenient time but without significantly taxing the device's batteries. Accordingly, the device can: (1) display evaluative information about the performance of the student with respect to a number of sets of problems, one set at a time; (2) even when turned off, retain that information for subsequent display when turned back on; and (3) when the score-memory is full, make room for each new score by eliminating from that memory the oldest score currently stored therein.

A fifth object is to provide such a learning aid that becomes fully operational almost instantly so that it can be time-efficiently used in numerous short (e.g., five-minute) practice sessions.

A sixth object is to not tempt the user with built-in distractions, such as games or internet access.

A seventh object is to incorporate most of the standard features traditionally included in electronic learning aids for teaching math facts.

An eighth object is to provide such a device that, despite its other attributes, is electrically self-sufficient, light, and compact enough to be easily and conveniently used by a young elementary-school student on a regular basis in virtually all potentially desirable locations, including, for instance, the classroom, the kitchen, and the school bus.

A ninth object is to provide such a device that, despite its other attributes, is sufficiently affordable to be purchased for every child of appropriate age, even if it is limited to teaching only fundamental arithmetic skills.

A tenth object is to provide such a device that provides timed exercises for the child, and particularly that increases the amount of time for responding to individual questions when the correct response has more than one digit.

An eleventh object is to provide such a device that accurately counts the number of incorrect answers, and more particularly, which substantially prevents counting single incorrect multiple digit answers as being a plurality of separate incorrect answers.

Still further objects and advantages will become apparent from consideration of the ensuing description and drawings.

### BRIEF DESCRIPTION OF THE DRAWINGS

FIGS. 1A and B show exterior top and right side views of an inexpensive, young-child-portable, battery-powered electronic learning aid for teaching arithmetic skills in accordance with the invention.

FIG. 2 shows an enlarged graphic layout of a liquid crystal display (LCD) for such a learning aid.

FIG. 3A shows an enlarged graphic layout of a 13-segment array for the LCD for visually representing either an addition symbol, a subtraction symbol, a multiplication symbol, a division symbol, or a combination of all four symbols (composite operator).

FIG. 3B shows an enlarged graphic layout of those segments of the LCD used to display an addition symbol.

FIG. 3C shows an enlarged graphic layout of those segments of the LCD used to display a subtraction symbol.

FIG. 3D shows an enlarged graphic layout of those segments of the LCD used to display a multiplication symbol.

FIG. 3E shows an enlarged graphic layout of those segments of the LCD used to display a division symbol.

FIG. 4 shows a block diagram of the preferred embodiment of the invention.

Similar reference characters indicate similar parts throughout the several views of the drawings.

### REFERENCE NUMERALS

8 electronic learning aid
9 speaker
10 case
11 display
12 10 single-digit number keys
13 PRACTICE key
14 TEST key
15 FLASHCARDS key
16 TABLE-IN-ORDER key
17 TABLE-NO-ORDER key
18 SPECIAL PROBLEMS key
19 TIME LIMIT key
20 +−×÷ key
21 LEVEL # OR TABLE # key
22 START key
23 SOUND switch
24 ON/OFF key
25 PAUSE key
26 HIDE OR SHOW COUNTDOWN key
27 ERASE MISSED OR ENTERED PROBLEMS key
28 ENTER PROBLEMS key
29 SEE RESULTS key
30 ERASE RESULTS key
31 PROBLEM FORMAT key
32 = flag
33 PRACTICE flag
34 TEST flag
35 FLASHCARDS flag
36 TABLE: flag
37 I flag
38 N flag
39 O flag
40 ORDER flag
41 SPECIAL PROBS flag
42 HID flag
43 sound-OFF flag
44 sound-LOW flag
45 two-sound-waves flag
46 RESULT flag
47 MISSED flag
48 ENTERED flag
49 LEVEL flag
50 −TABLE flag
51 SECONDS flag
52 PAUSED flag
53 NO flag
54 PROBLEMS IN MEMORY flag
55 TRY AGAIN flag
56 WOW!! flag
57 left-side CORRECT flag
58 RELATIVE LENGTH OF PROMPTS flag
59 ATTEMPTED flag
60 NORM=5 flag
61 NOT flag
62 small % flag
63 right-side CORRECT flag
64 large % flag
65 earphone jack
66 compound LCD unit used in display of each of four arithmetic symbols
67 microprocessor
68 all keys collectively
69 volatile memory
70 long-term memory
71 batteries
110-122 LCD segments making up compound LCD unit 66

### DETAILED DESCRIPTION OF THE INVENTION

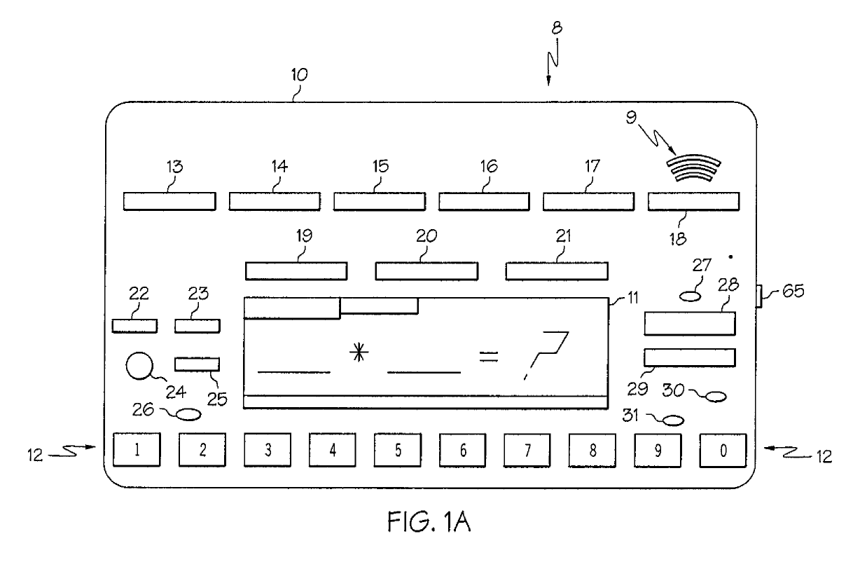

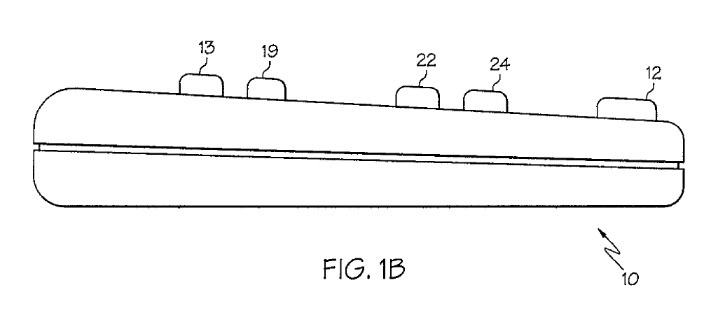

In accordance with the invention, FIGS. 1A and 1B show exterior top- and left-side views of a preferred embodiment of an inexpensive, portable, battery-powered electronic learning aid 8 for teaching arithmetic skills to students as young as seven years old. The learning aid comprises a case 10 which houses the device's electronic components. As shown in FIG. 1B, the case is shaped like a truncated wedge with rounded edges. When positioned for use on a flat surface in front of a user, the case's width is approximately 18.8 centimeters (7.4 inches), its height is approximately 10.9 centimeters (4.3 inches), and it slopes slightly down toward the user since it is thickest, approximately 2.0 centimeters (0.8 inch), along its far edge and thinnest, approximately 1.3 centimeters (0.5 inch), along its nearest edge. The case will generally be made of high impact plastic such as polystyrene or ABS, although other materials used in the manufacture of computer and game cases, including lightweight metal alloys can also be used.

Two AA size batteries are replaceable in the case through a battery door (not shown) although other embodiments can use different numbers and types of batteries. Alternatively, solar cells could be used in those instances in which they supply sufficient power for operation of the device. On the exterior of the case, in communication with the electronics of the interior, is a display 11 for visual communication of problems and other information to a user. Display 11 is entirely a liquid crystal display (LCD), but a light emitting diode (LED) display or a combination of LCD and LED technology can be used. The display is approximately 10.7 centimeters (4.2 inches) wide and 4.1 centimeters (1.6 inches) high, and its visible portion is approximately 10.2 centimeters (4.0 inches) wide and 2.90 centimeters (1.14 inches) high.

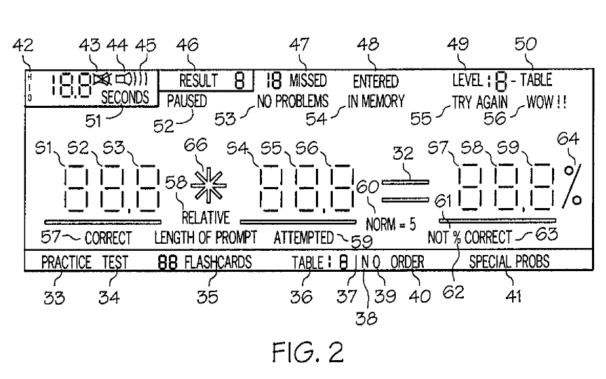

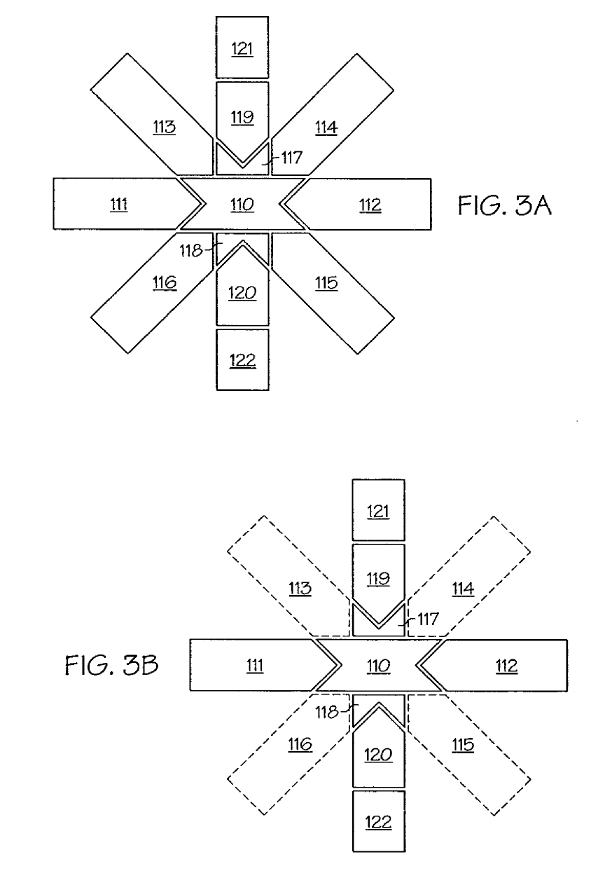

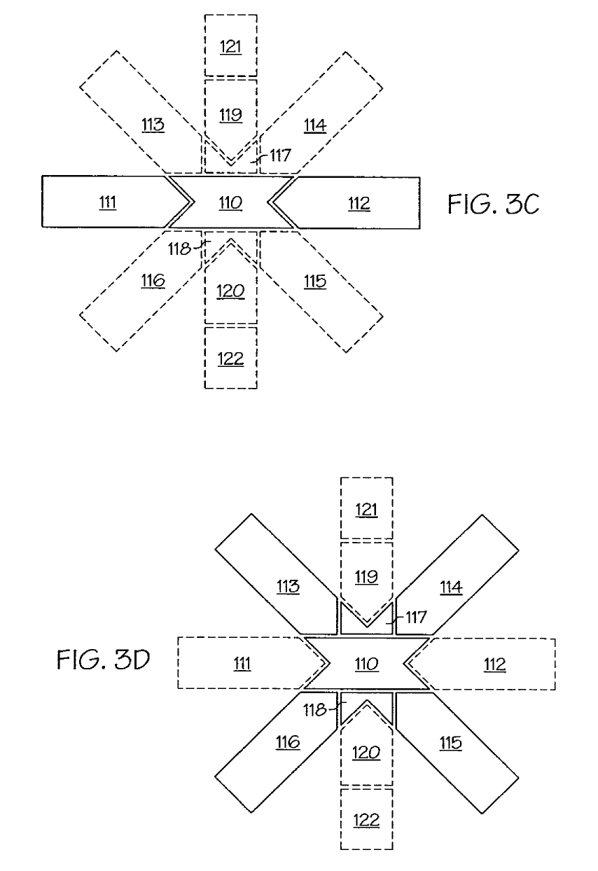

Among other things, as shown in FIGS. 2 and 3A, the display includes a 13-segment array 66 (FIG. 3A) for visually representing either: an addition symbol (FIG. 3B), a subtraction symbol (FIG. 3C), a multiplication symbol (FIG. 3D), and a division symbol (FIG. 3E), one symbol at a time, or a combination of the components of all four symbols (composite operator). All five of these representations use an approximately-hexagonal liquid-crystal central segment 110 (FIG. 3A) as their central display segment. The segments of the 13-segment array 66 are labeled 110-122. As shown in FIG. 3B, an addition symbol is shown by activating segments 110, 111, 112, 117, 118, 119, 120, 121, and 122. (Non-activated segments in the drawings are indicated by dashed lines.) Similarly, as seen in FIG. 3C, a subtraction symbol is displayed by activating segments 110, 111, and 112. Turning to FIG. 3D, a multiplication symbol is displayed by activating segments 110, 113, 114, 115, 116, 117, and 118. Finally, a division symbol (FIG. 3E) is displayed by activating segments 110, 111, 112, 121, and 122.

On the exterior of the case (FIG. 1A), in communication with the electronics of the interior are keys 29 and a three-position SOUND switch 23. The keys and the switch together constitute a user input system by which the operation of the learning aid is controlled and responses to questions are received. Of course, SOUND switch 23 can be replaced, if desired, by a single toggle key to provide simple sound-ON and sound-OFF capability. It should also be realized that user input can alternatively be made by means of a stylus and a touch-sensitive pad. Such input systems in the personal digital assistant art are well-known. A stylus input system is contemplated as being the equivalent of the keyboard input system described herein.

Switch 23 is horizontally-oriented, and, from left to right, its three positions are: OFF, LOW, and HIGH. It controls the output of a speaker (not shown) inside case 10 and the output of any earphones that are plugged into an earphone jack 65 located on the right edge of the exterior of case 10 and shown in FIG. 1A. In the alternative the speaker could be replaced by a piezoelectric transducer.

The keys are, in general, assigned as follows, as more accurately and fully explained further below:

Ten single-digit number keys 12 enter answers and other numeric input relating
to certain below-described ancillary functions, the keys being arranged horizontally from left to right in the order of 1, 2, 3, 4, 5, 6, 7, 8, 9, and 0.
ON/OFF key 24 changes the learning aid from a standby-power-on state to a main-power-on state and vice-versa.
PRACTICE key 13 selects a Practice learning mode.
TEST key 14 selects a Test learning mode.
FLASHCARDS key 15 selects a Flashcards learning mode and performs an ancillary function discussed below.
TABLE-IN-ORDER key 16 selects a Table-In-Order learning mode.
TABLE-NO-ORDER key 17 selects a Table-No-Order learning mode.
SPECIAL PROBLEMS key 18 selects a Special Problems learning mode.
TIME LIMIT key 19 selects: a per-activity (i.e., per-set-of-problems) time limit if the Practice, Test or Special Problems learning mode is selected, and a per-problem time limit if the Flashcards learning mode is selected. +−×÷ key 20 selects among the arithmetic operations of addition, subtraction, multiplication, and division if any learning mode, other than the Special Problems learning mode, is selected or if the enter-problems function, discussed below, is being used.
LEVEL # OR TABLE # key 21 selects under appropriate circumstances among nine levels for each of the four arithmetic operations in connection with the Practice, Test or Flashcards learning mode and among 10 addition tables, 10 subtraction tables, 13 multiplication tables, and 12 division tables in connection with the Table-In-Order or Table-No-Order learning mode.
PAUSE key 25 pauses or restarts the presentation of problems and the counting down of the time limit when the Practice or the Special Problems learning mode is selected, and performs two ancillary functions discussed below.
START key 22 starts the presentation of problems and also restarts the presentation of problems paused by PAUSE key 25.
HIDE OR SHOW COUNTDOWN key 26 prevents or allows the displaying of the counting down of a per-activity or per-problem time limit and performs two ancillary functions discussed below.
ERASE MISSED OR ENTERED PROBLEMS key 27 erases all problems stored in volatile memory, whether they are missed problems or entered problems.
ENTER PROBLEMS key 28 initiates and finalizes the process of entering into memory problems to be presented in the entered-problems aspect of the Special Problems mode.
SEE RESULTS key 29 causes display 11 to display information about past efforts to answer problems.
ERASE RESULTS key 30 erases all information stored in memory about past efforts to answer problems.
PROBLEM FORMAT key 31 selects the format of problems being presented and performs two ancillary functions discussed below.

All the keys preferably are made of bard plastic. The PRACTICE, TEST, FLASHCARDS, TABLE-IN-ORDER, TABLE-NO-ORDER, and SPECIAL PROBLEMS keys are yellow, and the SEE RESULTS and START keys are green. The green color of the START key signifies its “starting” function. Display 11 has a reflector (not shown) which is mostly very light gray in color, but portions of the reflector are yellow and green to link information displayed above them thematically with the just-specified yellow keys and the green SEE RESULTS key.

HIDE OR SHOW COUNTDOWN key 26, ERASE MISSED OR ENTERED PROBLEMS key 27, ERASE RESULTS key 30, and PROBLEM FORMAT key 31 (the four small recessed keys) are all recessed below the surface of the top of case 10 to lessen the possibility of inadvertent activation. ON/OFF key 24 is similarly recessed for the same reason.

The preferred embodiment uses for its question engine a Sunplus SPL31A integrated chip (not shown) made by Sunplus Technology Co., Ltd., Taiwan, which is an eight-bit complementary metal oxide semiconductor (CMOS) single-chip microprocessor which includes: 160 bytes of random access memory, 64 kilobytes of read only memory, seven input ports, 12 general purpose input or output ports, an interrupt or wakeup controller, a built-in 32.768 kilohertz oscillator circuit for real clock function, two 16-bit timers or counters, a power down mode, two eight-bit pulse-width-modulation audio outputs supporting two sound channels, and an automatic display controller and driver for an LCD. Obviously, this chip is just one example of a suitable integrated circuit chip that can be used for the invention. Other embodiments could use other integrated circuit chips or combinations of a plurality of such chips. An example of such an embodiment is the use of a second integrated circuit to manage the keyboard. This second integrated circuit could be an additional SPL31A or some other similar type integrated circuit.

The Sunplus SPL31A chip is programmed with an assembly code program written with the custom software provided by the above-named manufacturer of the chip for the programming of that chip. The various steps performed by the program are set forth below, and of course the program instructions to perform those steps will vary depending upon the particular processor used. Preparation of such a program is well within the skill of one of ordinary skill in the art of programming microprocessor devices, and so is not described in detail herein. No invention is claimed in the particular programming steps unique to the Sunplus SPL31A microprocessor.

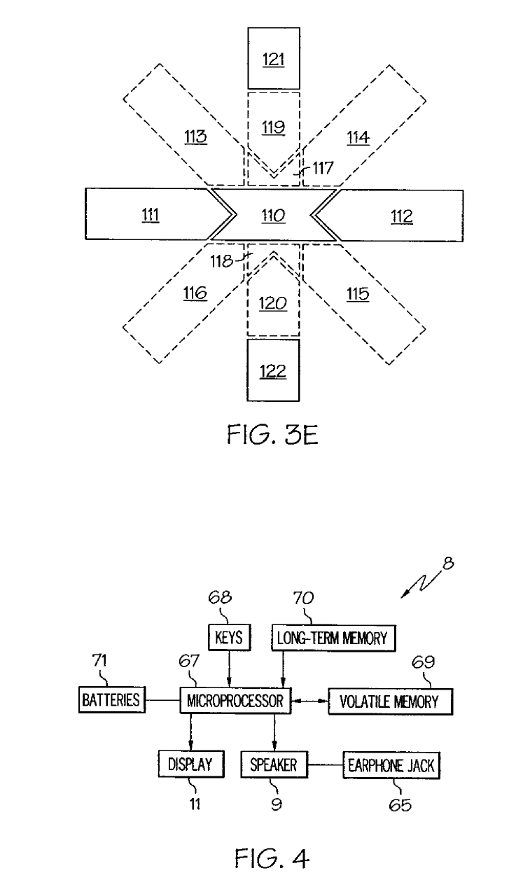

FIG. 4 is a block diagram of the functional components of the learning aid. Although the interaction of the various components of learning aid 8 will become clearer in connection with the description of its operation below, a brief overview is presented here. The question engine or microprocessor 67 is suitably connected to the two “AA” batteries 71 to provide power to the device. Although only the connection to the microprocessor is explicitly shown, it should be understood that the batteries provide the power for all the electronic components shown, including the memories, the display and the speaker. Microprocessor 67 receives user input information via keys 68, which constitute all the keys shown on the face of the unit in FIG. 1A. Basic output is provided to display 11 (for visual output) and a speaker 9 (for aural output). (It should be understood that the speaker is physically located inside the case as the location indicated in FIG. 1 by reference numeral 9.) Microprocessor 67 has both volatile memory 69 and long-term memory 70. Although these are shown as physically separate from the microprocessor, it should be understood that memory of either type could be incorporated into the microprocessor itself. The actual location and form of the memory is not critical, so long as the resulting device is of such a size and weight that it can be easily carried and used by a young child. It should also be understood that various interface devices may or may not be included between the microprocessor and the other components shown in FIG. 4 depending upon the particular components being used. The particular interfaces used are of no importance to this invention.

Arithmetic Skills Taught

The purpose of this embodiment is to help a user to learn to answer correctly all the following arithmetic problems and to answer correctly and very rapidly the arithmetic problems specified in the first, fourth, seventh, and tenth subparagraphs below:

1) the 100 addition problems having two known addends and an unknown sum, where the addends are whole numbers greater than or equal to 0 and less than 10, e.g., 1+2=?;

2) the 100 addition problems having an unknown first addend, a known second addend, and a known sum, where the two addends are whole numbers greater than or equal to 0 and less than 10, e.g., ?+2=3;

3) the 100 addition problems having a known first addend, an unknown second addend, and a known sum, where the two addends are whole numbers greater than or equal to 0 and less than 10, e.g., 1+?=3;

4) the 100 subtraction problems having a known minuend, a known subtrahend, and an unknown difference, where the subtrahend and the difference are whole numbers greater than or equal to 0 and less than 10, e.g., 3−1=?;

5) the 100 subtraction problems having an unknown minuend, a known subtrahend, and a known difference, where the subtrahend and the difference are whole numbers greater than or equal to 0 and less than 10, e.g., ?−1=2;

6) the 100 subtraction problems having a known minuend, an unknown subtrahend, and a known difference, where the subtrahend and the difference are whole numbers greater than or equal to 0 and less than 10, e.g., 3−?=2;

7) the 169 multiplication problems having a known multiplicand, a known multiplier, and an unknown product, where the multiplicand and multiplier are whole numbers greater than or equal to 0 and less than 13, e.g., 2×3=?;

8) the 169 multiplication problems having an unknown multiplicand, a known multiplier, and a known product, where the multiplicand and multiplier are whole numbers greater than or equal to 0 and less than 13, e.g., ?×3=6;

9) the 169 multiplication problems having a known multiplicand, an unknown multiplier, and a known product, where the multiplicand and multiplier are whole numbers greater than or equal to 0 and less than 13, e.g., 2×?=6;

10) the 156 division problems having a known dividend, a known divisor, and an unknown quotient, where the divisor is a whole number greater than 0 and less than 13 and the quotient is a whole number greater than or equal to 0 and less than 13, e.g., 6÷3=?;

11) the 156 division problems having an unknown dividend, a known divisor, and a known quotient, where the divisor is a whole number greater than 0 and less than 13 and the quotient is a whole number greater than or equal to 0 and less than 13, e.g., ?÷3=2; and

12) the 156 division problems having a known dividend, an unknown divisor, and a known quotient, where the divisor is a whole number greater than 0 and less than 13 and the quotient is a whole number greater than or equal to 0 and less than 13, e.g., 6÷?=2.

Learning Modes/Learning Activities

A user can engage in any of the following six basic types of learning activities or learning modes: (1) Table-In-Order drills; (2) Table-No-Order drills; (3) Practice drills; (4) Test drills; (5) Flashcards drills; and (6) Special Problems drills. These will be explained below. Whenever the learning aid is ON, the display illuminates one of the following visual flags or combinations of flags illustrated in FIG. 2: a PRACTICE flag 33, a TEST flag 34, a FLASHCARDS flag 35, a SPECIAL PROBS flag 41, TABLE: IN ORDER (the combination of: a TABLE: flag 36, an I flag 37, an N flag 38, and an ORDER flag 40), or TABLE: NO ORDER (the combination of: TABLE: flag 36, N flag 38, an O flag 39, and ORDER flag 40), thereby signifying one and only one of these learning activities—with only one exception, namely, when no results are stored in memory and SEE RESULTS key 29 is pushed.

Turning ON the Learning Aid

Pushing ON/OFF key 24 turns the learning aid from OFF (i.e., its main-power-off-standby-power-on state) to ON (i.e., its main-power-on state) and vice versa. In general, it is assumed below that the learning aid is ON. Of course, ON/OFF key 24 could equivalently be replaced by automatic power-down circuitry. Such circuitry is well-known and is intended to be within the scope of the present invention.

Introduction to See-Results Function

In general, pressing SEE RESULTS key 29 one to nine times displays the results of the up to nine learning activities most recently performed, beginning with the activity most recently performed. When the SEE RESULTS key is pressed, display 11 displays a RESULT flag 46 followed by a single-digit number indicating which of the nine most recent results is being displayed—the more recent the result, the higher the number. If no results are currently in memory, a 0 is displayed.

Whenever the results of a learning activity are displayed, among other things, the flag of that activity is displayed. When a learning activity is completed, the results of that learning activity are displayed automatically, i.e., without the pressing of the SEE RESULTS key.

Change-Problem-Format Function

Problems are displayed in the vertically-central, horizontal portion (the problem portion) of display 11. (FIG. 2) If the change-problem-format function has not been used since the learning aid has most recently been turned ON, all problems displayed are in the normal horizontal format, namely a specified first (left) operand, a specified operator (+, −, ×, or ÷), a specified second (right) operand, and a representation of a ? in the normal space for the answer. The user has the option of changing the problem format by pushing PROBLEM FORMAT key 31. The first push of key 31 changes the problem format so that the problem asks the user to enter as the answer the left operand for an equation where the operator, the right operand, and the sum, difference, product, or quotient, as the case may be, are specified. A second push of the PROBLEM FORMAT key changes the problem format so that the problem asks the user to enter as the answer the right operand for an equation where the left operand, the operator, and the sum, difference, product, or quotient, as the case may be, are specified. A third push of the key reinstates the default problem format. And so on. The currently applicable problem format is shown by the illumination of a ? in the appropriate location. Unless otherwise indicated, it is assumed below that the learning aid is in the default problem format.

SOUND Switch and Earphone Jack

As discussed in greater detail below, under certain circumstances sound effects are generated. There are three possible sound levels: OFF, LOW, and HIGH. Which level is currently in effect is governed by three-position horizontally-slidable SOUND switch 23. Alternatively, switch 23 may be a simple toggle switch if only sound OFF and sound ON are desired. When the learning aid is ON, the sound level is also reflected by the illumination of the appropriate flag or flags in display 11: OFF by a sound-OFF flag 43, a crossed-out megaphone; LOW by a sound-LOW flag 44, a megaphone with one sound wave; and HIGH by the combination of flag 44 and two-additional sound-waves flag 45. Of course, when only sound OFF and sound ON are used, the sound OFF status is represented by sound-OFF flag 43, and the sound ON status is represented by the megaphone with three sound wave flags (i.e., identical to the flags for the HIGH volume state described above). Switching from one sound level to another does not alone generate any sound. Unless otherwise indicated, the following discussion assumes that either the LOW or HIGH sound level is selected and that the appropriate flag or flags are displayed.

When an earphone device is plugged into earphone jack 65, any sound effects are audible only through that device.

Overview of Operation of Learning Activities—an Idea of how the Learning Aid Works

Step #1: When the learning aid is ON, the user presses the appropriate one of six yellow learning activity keys 13, 14, 15, 16, 17, and 18 to set (poise) the device for the desired learning activity, as reflected by the illumination of the flag or flags corresponding to that activity.

Step #2:

A. The user skips this step if: either (a) in the case of the Test, Practice, or Special Problems learning activity, the desired per-activity time limit (i.e., per-set-of-problems time limit) is already displayed, or (b) in the case of the Flashcards learning activity, the desired per-problem time limit is already displayed; or (c) the Table-In-Order or Table-No-Order learning activity is selected since neither of these two activities involves a time limit.

B. Otherwise, the user selects the desired time limit by pushing the TIME LIMIT key one or more times until the desired time limit is displayed in seconds or sometimes in the case of the Flashcards learning activity, in seconds and tenths of seconds.

Step #3:

A. The user skips this step if: either (a) the symbol of the desired arithmetic operation (+, −, × or ÷) is already displayed, or (b) the selected learning activity is Special Problems since this activity is not limited to problems of only one arithmetic operation.

B. Otherwise, the user presses the +−×÷ key one or more times until the symbol of the desired arithmetic operation is displayed.

Step #4:

A. The user skips this step if: either (a) in the case of the Test, Practice or Flashcards learning activity, the number of the desired level of difficulty is already displayed to the right of a displayed LEVEL flag 49; or (b) in the case of the Table-In-Order or the Table-No-Order learning activity, the number of the desired table is already displayed immediately to the left of a displayed —TABLE flag 50; or (c) the selected learning activity is Special Problems since this activity entails neither a difficulty level nor a table.

B. Otherwise, the user selects the desired difficulty level or table number by pushing LEVEL # OR TABLE # key 21 one or more times until the appropriate number is displayed.

Step #5: The user presses START key 22 to start the desired learning activity—that is, to start the presentation of the problems to be answered.

Step #6: The user answers the arithmetic problems displayed by depressing appropriate number keys 12. Answers are entered from left to right. For instance, the math problem 8+9=? is answered by pushing first the 1 key and then the 7 key.

The Terms “In Progress”, “Last-selected”, “Poised”, and “Poise”

A learning activity is “in progress” when that activity is selected and problems are currently being presented.

The “last-selected” learning activity, table number, level number, arithmetic operation, or time limit is the one that has been most recently displayed in display 11 when RESULT flag 46 was not also displayed.

The learning aid is “poised” or “set” for a particular learning activity when all the following four conditions exist: (1) pushing START key 22 will start that learning activity; (2) RESULT flag 46 is not displayed; (3) the learning activity is not already in progress; and (4) the learning activity is not paused—a situation that, as explained below, can occur only in the Practice or the Special Problems learning activity. Whenever the learning aid is poised for a learning activity, that activity's flag is displayed, but the learning aid is not always poised for a learning activity when that activity's flag is displayed. When the learning aid is poised for a learning activity, pushing START key 22 always starts that activity. But pushing the START key in some situations starts a learning activity when the learning aid is not poised for that activity. For instance, if a learning activity is in progress, pushing the START key starts that activity from the beginning. Or, if RESULT flag 46 is displayed, pushing the START key starts the last-selected learning activity.

Digit and ? Placement when a Learning Activity is in Progress

As illustrated in FIG. 2, across the problem portion of display 11, there are nine horizontally-arranged spaces for large digits. Below these spaces are referred to, from left to right, as S1, S2 . . . S9. When appropriate, a representation of a ? is displayed in: S2, S5, or S9 (not S8). The ? is represented by displaying: (1) the five LCD segments normally used to display the digit 2 minus the horizontal segment normally used to display the base of the 2, and (2) a rectilinear dot-like LCD segment located below the lower end of the segment representing the vertical stem of the 2. (FIG. 2)

When learning activities are in progress, problems are presented as follows:

1. In the left-operand spaces, single-digit operands are displayed in S2, two-digit operands are displayed in S1 and S2, and three-digit operands are displayed in S1, S2 and S3.

2. In the right-operand spaces, single-digit operands are displayed in S5, and two-digit operands are displayed in S4 and S5. Three-digit right operands, if desired, are displayed in S4, S5 and S6.

3. When the user is being asked to enter a left or right operand as an answer, then, in the location where normally answers appear, single-digit numbers are displayed in S9, two-digit numbers in S8 and S9, and three-digit numbers in S7, S8 and S9.

When learning activities are in progress, answers are displayed as follows:

1. In the normal location for answers:

a. Single-digit numbers appear in S9.

b. When the left digit of a two-digit answer is typed, it first appears in S9, but when the right digit of that two-digit number is typed, the right digit appears in S9 and the left digit moves to S8.

c. When the leftmost digit of a three-digit number is typed, it first appears in S9, and when the middle digit of the three-digit number is typed, that middle digit appears in S9, and the leftmost digit moves to S8, and finally when the rightmost digit of the three-digit number is typed, the rightmost digit appears in S9, the middle digit moves to S8, and the leftmost digit moves to S7.

2. In the right-operand location:

a. Single-digit numbers appear in S5.

b. When the left digit of a two-digit number is typed, it first appears in S5, but when the right digit of that two-digit number is typed, the right digit appears in S5 and the left digit moves to S4.

c. There are no three-digit right operands.

3. In the left-operand location, the learning aid first determines whether the correct answer consists of three digits or not.

a. If the correct answer consists of fewer than three digits, the entered number is displayed as follows. Single-digit numbers appear in S2. When the left digit of a two-digit number is typed, it first appears in S2, but when the right digit of that two-digit number is typed, the right digit appears in S2 and the left digit moves to S1.

b. If the correct answer consists of three digits, when the leftmost digit is typed, it first appears in S3, but when the middle digit is typed, the middle digit appears in S3, and the leftmost digit moves to S2, and finally when the rightmost digit is typed, the rightmost digit appears in S3, the middle digit moves to S2, and the leftmost digit moves to S8.

Table-In-Order Learning Activity-Explanation by Means of Illustrations

If a user selects the Table-In-Order learning activity, selects addition as the arithmetic operation, and selects 7 as the table number, then display 11 displays:—TABLE flag 50; a 7 to the immediate left of flag 50; the addition symbol (FIG. 3B) between S3 and S4; and flags 36, 37, 38, and 40 constituting TABLE: IN ORDER. No numbers are then displayed in the problem portion of display 11. But the following are displayed from left to right: a continuous horizontal line made up of three adjacent LCD segments below S1, S2, and S3, the spaces for the left operand; the just-mentioned addition symbol; a second continuous horizontal line made up of three adjacent LCD segments below S4, S5 and S6, the spaces for the right operand; an =flag 32 between S6 and S7; and a ? in S9 but no underlining under S7, S8 and S9 (again, assuming that the default 1+2=? problem format applies). (FIG. 2)

At this point, the learning aid is poised to start the Table-In-Order learning activity with respect to the “7” addition table. If the user then pushes START key 22, the learning aid presents the following problems—with no underlinings—in the following order: 7+0=?, 7+1=?, 7+2=?, 7+3=?, 7+4=?, 7+5=?, 7+6=?, 7+7=?, 7+8=?, 7+9=?, 9+7=?, 8+7=?, 7+7=?, 6+7=?, 5+7=?, 4+7=?, 3+7=?, 2+7=?, 1+7=?, and 0+7=?.

If subtraction is and the “4” table are then selected, the learning aid, when started, presents: 4−4=?, 5−4=?, 6−4=?, 74=?, 84=?, 9−4=?, 10−4=?, 11−4=?, 12−4=?, 13−4=?, 12−4=?, 11−4=?, 104=?, 9−4=?, 84=?, 7−4=?, 6−4=?, 54=?, 4−4=?. The problem 13−4=? is presented only once in order to avoid possible confusion from a problem reappearing immediately after being answered correctly.

If division and the “8” table are then selected, the learning aid, when started, presents: 0÷8=?, 8÷8=?, 16÷8=?, 24÷8=?, 32÷8=?, 40÷8=?, 48÷8=?, 56÷8=?, 64÷8=?, 72÷8=?, 80÷8=?, 72÷8=?, 64÷8=?, 56÷8=?, 48÷8=?, 40÷8=?, 32÷8=?, 24÷8=?, 16÷8=?, 8÷8=?, 0÷˜8=?. The problem 80÷8=? is presented only once in order to avoid possible confusion from a problem reappearing immediately after being answered correctly.

If the PROBLEM FORMAT key 31 is then pushed until the ? is displayed in S5, the learning aid, when started, presents: 0÷?=0, 8÷?=1, 16÷?=2, 24÷?=3, 32÷?=4, 40÷?=5, 48÷?=6, 56÷?=7, 64÷?=8, 72÷?=9, 80÷?=10, 72÷?=9, 64÷?=8, 56÷?=7, 48÷?=6, 40÷?=5, 32÷?=4, 24÷?=3, 16÷?=2, 8÷?1, 0?=0. Any non-zero, single-digit answer, not just 8, is accepted as a correct answer to the first and last problems.

Then if multiplication and the “4” table are selected, the learning aid, when started, presents: 4×?=0, 4×?=4, 4×?=8, 4×?=12, 4×?=16, 4×?=20, 4×?=24, 4×?=28, 4×?=32, 4×?=36, 4×?=40, 10×?=40, 9×?=36, 8×?=32, 7×?=28, 6×?=24, 5×7=20, 4×?=16, 3×?=12, 2×?=8, 1×?=4, 0×?0. Any single-digit answer, not just 4, is accepted as a correct answer to the last problem.

As a final example, if the “0” table and the ?+2=3 problem format are then selected, the learning aid, when started, presents: ?×0=0, ?×1=0, ?×2=0, ?×3=0, ?×4=0, ?×5=0, ?×6=0, ?×7=0, ?×8=0, ?×9=0, ?×10=0, ?×0=0, ?×0=0, ?×0=0, ?×0=0, ?×0=0, ?×0=0, ?×0=0, ?×0=0, ?×0=0, ?×0=0, ?×0=0. Any single-digit answer, not just 0, is accepted as a correct answer to the first last 11 problems.

Note that in the preceding illustrations involving division and multiplication, there are no problems involving 11 or 12. In the Table-In-Order learning activity (and in the Table-No-Order learning activity discussed below), 11 and 12 only appear as multiplicands, multipliers, quotients, or divisors in the “11” and “12” tables. For example, the “11” multiplication table includes the following problems: 11×0=?, 11×1=?, 1×2=?, 11×3=?, 11×4=?, 1×5=?, 11×6=?, 11×7=?, 1×8=?, 11×9=?, 11×10=?, 11×11=?, 11×12=?, 12×11=?, 11×11=?, 10×11=?, 9×11=?, 8×11=?, 7×11=?, 6×11=?, 5×11=?, 4×11=?, 3×11=?, 2×11=?, 1×11=?, 0×11=?.

Table-In-Order Learning Activity—Treatment of Correct Answers

Upon the typing of the final digit of a correct answer in this learning activity (as in any other learning activity), a chord sound is emitted unless sound is switched to OFF. In addition, in the Table-In-Order learning activity the problem and correct answer remain displayed for 1.2 seconds (unless this length of the prompt is modified, as explained below) before the next problem is automatically presented. During the same time interval, a right-side CORRECT flag 63 located below S-8 and S-9 is displayed as well.

Table-In-Order Learning Activity—Treatment of Incorrect Answers

In the Table-In-Order activity, the typing of an incorrect digit—even if the answer is a multi-digit answer—initially results immediately in:

(1) the emission of a rapid, negative-sounding—but not unpleasant—sequence of two tones (the negative tones); and for 1.2 seconds (unless modified, as explained below): the display of the problem, the incorrect answer, a NOT flag 61, and right-side CORRECT flag 63; and then at the end of the 1.2 seconds, in:

(2) the incorrect answer and the NOT and the right-side CORRECT flags being extinguished; the continued display of the missed problem but now including a ? in the appropriate space, and the blinking display of a TRY AGAIN flag 55 at a rate of one-0.6 second ON and 0.4 second OFF.

At this point, the typing of an incorrect digit results in:

(3) the ? and TRY AGAIN flag 55 being extinguished; the emission of the negative tones; and for 1.2 seconds (unless modified as explained below): the display of the problem, the incorrect answer, NOT flag 61, and right-side CORRECT flag 63; and then at the end of the 1.2 seconds, in:

(4) the incorrect answer and NOT flag 61 being extinguished; and the display for 2.4 seconds (unless modified as explained below) of the problem along with the correct answer to it and the still-displayed right-side CORRECT flag below it; and then in:

(5) the correct answer and the right-side CORRECT flag being extinguished, the continued display of the missed problem—but now including a ?—and the blinking display of TRY AGAIN flag 55

At this point, the typing of an incorrect digit results in returning to step (3) of the five just-described steps.

Table-In-Order Learning Activity Automatic Display of Result of Activity

Upon the completion of the Table-In-Order learning activity, a pleasant-sounding multi-tone sound effect is emitted and simultaneously the following is displayed:
RESULT flag 46 followed on its right by a number from 1 to 9 corresponding to the number of learning activity results currently stored in memory, including this most recent result;
the number of all correct answers entered in S1, S2 and S3;
a horizontal line made up of three adjacent LCD segments below S1, S2 and S3;
a left-side CORRECT flag 57 directly below that line;
the number of all problems attempted in S4, S5 and S6;
a horizontal line made up of three adjacent LCD segments below S4, S5 and S6;
an ATTEMPTED flag 59 directly below that line;
a number corresponding to the percent-rounded to the nearest percent—of all the problems attempted that was answered correctly in S7, S8 and S9;
a horizontal line made of three adjacent LCD segments below S7, S8 and S9;
a large % flag 64 to the immediate right of the percentage number;
a small % flag 62 below S7;
right-side CORRECT flag 63;
the symbol of the operation practiced (+, −, ×, or ÷) between S3 and S4; and
the number of the designated table to the left of —TABLE flag 50; and flags 36, 37, 38, and 40 constituting TABLE. IN ORDER.

In addition, if 100% of the problems have been answered correctly and at least 20 problems have been answered, a WOW!! flag 56 blinks at a rate of 0.6 second ON and 0.4 second OFF.

Table-In-Order Learning Activity—Table Learning Activities not Subject to Time Limit

Unlike the other four learning activities, the Table-In-Order and Table-No-Order learning activities are not subject to any time limit.

Table-No-Order Learning Activity

There are six differences between the Table-In-Order learning activity and the Table-No-Order learning activity. Otherwise, the two activities are dealt with essentially in the same manner.

First, obviously, pushing TABLE-NO-ORDER key 17, not TABLE-IN-ORDER key 16, poises the learning aid for the Table-No-Order learning activity. And as a result, flags 36, 38, 39, and 40 constituting TABLE. NO ORDER are displayed instead of flags 36, 37, 38, and 40 constituting TABLE: IN ORDER.

Second, in the Table-No-Order learning activity, mistakes are dealt with as in the Table-In-Order learning activity, except that each incorrectly-answered problem is presented again immediately after the completion of the next new problem following it. For instance: The user answers 7×8 incorrectly but either on the next attempt (in response to the first illumination of TRY AGAIN flag 55) or after one or more additional attempts, answers the problem correctly. Then the learning aid presents a different problem (e.g., 4×7). After the user answers the new problem correctly, the learning aid presents 7×8 again. If, however, 7×8, is missed again, that mistake is treated like a mistake in the Table-In-Order learning activity. Moreover, if the user answers incorrectly the last remaining problem of the Table-No-Order learning activity, the problem is presented again immediately since there is not a “next problem” to follow.

Third, in the Table-No-Order learning activity, the arithmetic problems (of the applicable problem format) included in the designated table (e.g., the “7” table) are presented in an “almost random” (defined below) order, not in an ascending and then descending order as in the case of the Table-In-Order learning activity.

Fourth, in subtraction and division, in the Table-No-Order learning activity, each of the different arithmetic problems (of the applicable problem format) included in the designated table is presented twice. By contrast, as noted above, in subtraction and division, in the Table-In-Order learning activity, the same is true except that in the case of each table the arithmetic problem with the highest difference or quotient, as the case may be, is presented only once.

Fifth, in the Table-No-Order activity, after a problem has been answered correctly, the problem, the correct answer, and right-side CORRECT flag 63 remain displayed for 1.1 seconds (unless modified as explained below).

Sixth, in the Table-No-Order activity, after a problem has been answered incorrectly, the problem, the incorrect answer, and NOT flag 61 and right-side CORRECT flag 63 remain displayed for 1.1 seconds (unless modified as explained below).

Table Numbers

The table number is relevant only to the Table-In-Order and the Table-No-Order learning activities. The possible table numbers for addition and subtraction are 0 through 9. Those for multiplication are 0 through 12, and those for division are 1 through 12.

When the learning aid is turned from OFF to ON, it remembers and reverts to the table number that was last selected when it was last ON. The display does not illuminate this table number when the learning aid is poised for a learning activity that is not a Table learning activity, but the table number is, nevertheless, in memory.

When either of the TABLE keys is pushed, the last-selected table number is in effect and accordingly is usually displayed to the left of—TABLE flag 50. The table number can be changed by pushing LEVEL # OR TABLE # key 21, but only when—TABLE flag 50 is currently displayed, in which case a table number is also displayed. Under these circumstances, pushing LEVEL # OR TABLE # key 21 increases the currently-displayed table number (which is not necessarily the—until then—last-selected table number) by one unless it has reached its maximum value for the then-displayed arithmetic operation, in which case it changes to its lowest possible value for that arithmetic operation. If the LEVEL # OR TABLE # key is pushed while the results of a Table activity are being displayed, not only does the table number change, but also the learning aid poises itself for that particular Table activity in the currently-displayed arithmetic operation. If the LEVEL # OR TABLE # key is pushed while a Table activity is in progress, again, not only does the table number change, but also the learning aid poises itself for that particular Table activity in the currently-displayed arithmetic operation.

In some rare situations, pushing +−×÷ key 20 affects the table number. First, if +−×÷ key 20 is pushed while the results of a Table activity are being displayed, not only does the arithmetic operation change to the operation “following” the one that had just been displayed, but also the learning aid poises itself for that particular Table activity and—unless the exception described in the following paragraph applies—in the currently-displayed table number.

Second, if pushing the +−×÷ key changes the arithmetic operation to an operation with which the until-then displayed table number cannot be used, that table number changes to the numerically closest table number that can be used with the operation in question. For instance, if the display is showing 11-TABLE and the applicable operation is division, then pushing the +−×÷ key once changes the setting not only to addition, but also to the “9” table since the learning aid has no “11” or “10” table for addition. Similarly, if the display is showing STABLE and the applicable operation is multiplication, pushing the +−×÷ key once changes the setting not only to division, but also to the “1” table.

Occasionally, pushing TABLE: IN ORDER key 16 or TABLE-NO-ORDER key 17 can change the table number, but not the pushing of any other learning activity key. For instance, if (1) the learning aid is poised for the “12” multiplication table in either of the Table learning activities, (2) the learning activity is then changed by the pushing of any of the keys for the other (non-Table) learning activities, (3) the arithmetic operation is then changed to addition or subtraction while the learning aid is poised for that other (non-Table) learning activity, and (4) either the TABLE-IN-ORDER or the TABLE-NO-ORDER key is pushed (while addition or subtraction is still the last-selected arithmetic operation), then the pushing of the Table key not only poises the learning aid for that Table learning activity, but it also changes the Table setting from 12 to 9 since there is not a “12”, “11” or “10” Table in addition or subtraction. The result would be the same in the preceding example if the learning aid were turned OFF and then ON between step (1) and step (4).

Levels

The Practice, Test, and Flashcards learning activities have nine different levels of difficulty for each of the four arithmetic operations. The levels are designed to allow a user to concentrate on those problems that are currently most appropriate for the user's particular stage of learning. With respect to each level and arithmetic operation, each possible problem is assigned a relative probability ranging from 0 to 15. A problem assigned a relative probability of 0 with respect to a particular level never occurs when that level is selected. In effect, that problem is not included in that level. And, for instance, a problem with a relative probability of 15 occurs, on average, 15 times as frequently as a problem with a probability of 1 and three times as frequently as a problem with a relative probability of 5. The relative probabilities (on the 0 to 15 scale) for addition and subtraction are specified in Table 1, the probabilities for multiplication are specified in Table 2, and the probabilities for division are specified in Table 3, respectively. Each of the tables includes relative probabilities for the problem specified for the various possible levels of difficulty.

TABLE 1
ADDITION AND SUBTRACTION LEVELS

| PROBLEM | L #1 | L #2 | L #3 | L #4 | L #5 | L #6 | L #7 | L #8 | L #9 |
|---|---|---|---|---|---|---|---|---|---|
| 0 + 0 = 0 | 2 | 2 | 1 | 1 | 1 | 2 | 1 | 1 | 1 |
| 0 + 1 = 1 | 1 | 1 | 1 | 0 | 0 | 1 | 1 | 0 | 0 |
| 0 + 2 = 2 | 1 | 1 | 1 | 0 | 0 | 1 | 1 | 0 | 0 |
| 0 + 3 = 3 | 1 | 1 | 1 | 0 | 0 | 1 | 1 | 0 | 1 |
| 0 + 4 = 4 | 1 | 1 | 1 | 0 | 0 | 1 | 1 | 1 | 0 |
| 0 + 5 = 5 | 1 | 1 | 1 | 0 | 0 | 1 | 1 | 0 | 0 |
| 0 + 6 = 6 | 1 | 1 | 1 | 1 | 0 | 1 | 1 | 0 | 0 |
| 0 + 7 = 7 | 1 | 1 | 1 | 0 | 0 | 1 | 1 | 0 | 1 |
| 0 + 8 = 8 | 1 | 1 | 1 | 0 | 0 | 1 | 1 | 0 | 0 |
| 0 + 9 = 9 | 1 | 1 | 1 | 0 | 1 | 1 | 1 | 1 | 0 |
| 1 + 0 = 1 | 1 | 1 | 1 | 0 | 0 | 1 | 1 | 0 | 0 |
| 1 + 1 = 2 | 6 | 6 | 2 | 1 | 1 | 3 | 1 | 1 | 1 |
| 1 + 2 = 3 | 3 | 3 | 1 | 0 | 0 | 3 | 1 | 0 | 0 |
| 1 + 3 = 4 | 3 | 3 | 1 | 0 | 0 | 3 | 1 | 1 | 0 |
| 1 + 4 = 5 | 3 | 3 | 1 | 0 | 1 | 3 | 1 | 0 | 1 |
| 1 + 5 = 6 | 3 | 3 | 1 | 0 | 0 | 3 | 1 | 0 | 0 |
| 1 + 6 = 7 | 3 | 3 | 1 | 1 | 0 | 3 | 1 | 1 | 0 |
| 1 + 7 = 8 | 3 | 3 | 1 | 0 | 0 | 3 | 1 | 0 | 1 |
| 1 + 8 = 9 | 3 | 3 | 1 | 0 | 0 | 3 | 1 | 0 | 0 |
| 1 + 9 = 10 | 3 | 3 | 1 | 1 | 1 | 3 | 1 | 1 | 1 |
| 2 + 0 = 2 | 1 | 1 | 1 | 0 | 0 | 1 | 1 | 0 | 1 |
| 2 + 1 = 3 | 3 | 3 | 1 | 0 | 0 | 3 | 1 | 1 | 0 |
| 2 + 2 = 4 | 0 | 15 | 6 | 2 | 2 | 6 | 3 | 1 | 1 |
| 2 + 3 = 5 | 0 | 15 | 3 | 1 | 1 | 4 | 3 | 1 | 1 |
| 2 + 4 = 6 | 0 | 15 | 3 | 1 | 1 | 4 | 3 | 1 | 1 |
| 2 + 5 = 7 | 0 | 15 | 3 | 1 | 1 | 4 | 3 | 1 | 1 |
| 2 + 6 = 8 | 0 | 15 | 3 | 1 | 1 | 4 | 3 | 1 | 1 |
| 2 + 7 = 9 | 0 | 15 | 3 | 1 | 1 | 4 | 3 | 1 | 1 |
| 2 + 8 = 10 | 0 | 15 | 3 | 1 | 1 | 5 | 8 | 6 | 3 |
| 2 + 9 = 11 | 0 | 0 | 0 | 15 | 4 | 5 | 12 | 15 | 13 |
| 3 + 0 = 3 | 1 | 1 | 0 | 0 | 0 | 1 | 1 | 0 | 0 |
| 3 + 1 = 4 | 3 | 3 | 1 | 0 | 0 | 3 | 1 | 0 | 0 |
| 3 + 2 = 5 | 0 | 15 | 3 | 1 | 1 | 4 | 3 | 1 | 1 |
| 3 + 3 = 6 | 0 | 15 | 6 | 2 | 2 | 8 | 12 | 7 | 4 |
| 3 + 4 = 7 | 0 | 0 | 15 | 3 | 1 | 4 | 8 | 6 | 3 |
| 3 + 5 = 8 | 0 | 0 | 15 | 3 | 1 | 4 | 8 | 6 | 3 |
| 3 + 6 = 9 | 0 | 0 | 15 | 3 | 1 | 4 | 8 | 6 | 3 |
| 3 + 7 = 10 | 0 | 0 | 15 | 3 | 1 | 5 | 9 | 7 | 4 |
| 3 + 8 = 11 | 0 | 0 | 0 | 15 | 4 | 5 | 12 | 15 | 13 |
| 3 + 9 = 12 | 0 | 0 | 0 | 15 | 6 | 5 | 12 | 15 | 13 |
| 4 + 0 = 4 | 1 | 1 | 1 | 0 | 0 | 1 | 1 | 0 | 0 |
| 4 + 1 = 5 | 3 | 3 | 1 | 1 | 0 | 3 | 1 | 0 | 0 |
| 4 + 2 = 6 | 0 | 15 | 3 | 1 | 1 | 4 | 3 | 1 | 1 |
| 4 + 3 = 7 | 0 | 0 | 15 | 3 | 1 | 4 | 8 | 6 | 3 |
| 4 + 4 = 8 | 0 | 0 | 15 | 6 | 3 | 8 | 15 | 7 | 5 |
| 4 + 5 = 9 | 0 | 0 | 15 | 3 | 1 | 4 | 8 | 6 | 3 |
| 4 + 6 = 10 | 0 | 0 | 15 | 3 | 1 | 5 | 9 | 7 | 4 |
| 4 + 7 = 11 | 0 | 0 | 0 | 15 | 4 | 5 | 12 | 15 | 13 |
| 4 + 8 = 12 | 0 | 0 | 0 | 0 | 15 | 6 | 15 | 15 | 15 |
| 4 + 9 = 13 | 0 | 0 | 0 | 0 | 15 | 6 | 15 | 15 | 15 |
| 5 + 0 = 5 | 1 | 1 | 1 | 0 | 0 | 1 | 1 | 1 | 0 |
| 5 + 1 = 6 | 3 | 3 | 1 | 0 | 1 | 3 | 1 | 0 | 1 |
| 5 + 2 = 7 | 0 | 15 | 3 | 1 | 1 | 4 | 3 | 1 | 1 |
| 5 + 3 = 8 | 0 | 0 | 15 | 3 | 1 | 4 | 8 | 6 | 3 |
| 5 + 4 = 9 | 0 | 0 | 15 | 3 | 1 | 4 | 8 | 6 | 3 |
| 5 + 5 = 10 | 0 | 0 | 15 | 6 | 5 | 8 | 15 | 7 | 5 |
| 5 + 6 = 11 | 0 | 0 | 0 | 15 | 4 | 5 | 12 | 15 | 13 |
| 5 + 7 = 12 | 0 | 0 | 0 | 0 | 15 | 6 | 15 | 15 | 15 |
| 5 + 8 = 13 | 0 | 0 | 0 | 0 | 15 | 6 | 15 | 15 | 15 |
| 5 + 9 = 14 | 0 | 0 | 0 | 0 | 15 | 6 | 15 | 15 | 15 |
| 6 + 0 = 6 | 1 | 1 | 1 | 0 | 1 | 1 | 1 | 0 | 1 |
| 6 + 1 = 7 | 3 | 3 | 1 | 0 | 0 | 3 | 1 | 0 | 0 |
| 6 + 2 = 8 | 0 | 15 | 3 | 1 | 1 | 4 | 3 | 1 | 1 |
| 6 + 3 = 9 | 0 | 0 | 15 | 3 | 1 | 4 | 8 | 6 | 3 |
| 6 + 4 = 10 | 0 | 0 | 15 | 3 | 1 | 5 | 9 | 7 | 4 |
| 6 + 5 = 11 | 0 | 0 | 0 | 15 | 4 | 5 | 12 | 15 | 13 |
| 6 + 6 = 12 | 0 | 0 | 0 | 15 | 8 | 10 | 15 | 15 | 15 |
| 6 + 7 = 13 | 0 | 0 | 0 | 0 | 15 | 6 | 15 | 15 | 15 |
| 6 + 8 = 14 | 0 | 0 | 0 | 0 | 15 | 6 | 15 | 15 | 15 |
| 6 + 9 = 15 | 0 | 0 | 0 | 0 | 15 | 6 | 15 | 15 | 15 |
| 7 + 0 = 7 | 1 | 1 | 1 | 0 | 0 | 1 | 1 | 0 | 0 |
| 7 + 1 = 8 | 3 | 3 | 1 | 0 | 0 | 3 | 1 | 0 | 0 |
| 7 + 2 = 9 | 0 | 15 | 3 | 1 | 1 | 4 | 3 | 1 | 1 |
| 7 + 3 = 10 | 0 | 0 | 15 | 3 | 1 | 5 | 9 | 7 | 4 |
| 7 + 4 = 11 | 0 | 0 | 0 | 15 | 4 | 5 | 12 | 15 | 13 |
| 7 + 5 = 12 | 0 | 0 | 0 | 0 | 15 | 6 | 15 | 15 | 15 |
| 7 + 6 = 13 | 0 | 0 | 0 | 0 | 15 | 6 | 15 | 15 | 15 |
| 7 + 7 = 14 | 0 | 0 | 0 | 15 | 15 | 10 | 15 | 15 | 15 |
| 7 + 8 = 15 | 0 | 0 | 0 | 0 | 15 | 6 | 15 | 15 | 15 |
| 7 + 9 = 16 | 0 | 0 | 0 | 0 | 15 | 6 | 15 | 15 | 15 |
| 8 + 0 = 8 | 1 | 1 | 1 | 1 | 0 | 1 | 1 | 1 | 0 |
| 8 + 1 = 9 | 3 | 3 | 1 | 0 | 0 | 3 | 1 | 1 | 0 |
| 8 + 2 = 10 | 0 | 15 | 3 | 1 | 1 | 5 | 8 | 6 | 3 |
| 8 + 3 = 11 | 0 | 0 | 0 | 15 | 4 | 5 | 12 | 15 | 13 |
| 8 + 4 = 12 | 0 | 0 | 0 | 0 | 15 | 6 | 15 | 15 | 15 |
| 8 + 5 = 13 | 0 | 0 | 0 | 0 | 15 | 6 | 15 | 15 | 15 |
| 8 + 6 = 14 | 0 | 0 | 0 | 0 | 15 | 6 | 15 | 15 | 15 |
| 8 + 7 = 15 | 0 | 0 | 0 | 0 | 15 | 6 | 15 | 15 | 15 |
| 8 + 8 = 16 | 0 | 0 | 0 | 15 | 15 | 10 | 15 | 15 | 15 |
| 8 + 9 = 17 | 0 | 0 | 0 | 0 | 15 | 6 | 15 | 15 | 15 |
| 9 + 0 = 9 | 1 | 1 | 1 | 0 | 0 | 1 | 1 | 0 | 0 |
| 9 + 1 = 10 | 3 | 3 | 1 | 1 | 1 | 3 | 1 | 1 | 1 |
| 9 + 2 = 11 | 0 | 0 | 0 | 15 | 4 | 5 | 12 | 15 | 13 |
| 9 + 3 = 12 | 0 | 0 | 0 | 15 | 6 | 5 | 12 | 15 | 13 |
| 9 + 4 = 13 | 0 | 0 | 0 | 0 | 15 | 6 | 15 | 15 | 15 |
| 9 + 5 = 14 | 0 | 0 | 0 | 0 | 15 | 6 | 15 | 15 | 15 |
| 9 + 6 = 15 | 0 | 0 | 0 | 0 | 15 | 6 | 15 | 15 | 15 |
| 9 + 7 = 16 | 0 | 0 | 0 | 0 | 15 | 6 | 15 | 15 | 15 |
| 9 + 8 = 17 | 0 | 0 | 0 | 0 | 15 | 6 | 15 | 15 | 15 |
| 9 + 9 = 18 | 0 | 0 | 0 | 15 | 15 | 10 | 15 | 15 | 15 |
| | 74 | 284 | 294 | 282 | 471 | 425 | 737 | 672 | 602 |

Explanatory Notes:
1. “L” = “Level”. The columns labeled “L #[number]” show the relative frequency of each problem in the enumerated level. Problem frequency is rated from 0 to 15. For example, a problem rated 15, on average, is presented 15 times as often as a problem rated 1 and three times as often as a problem rated 5. A problem rated 0 is not included in the level in question.
2. The composition of the subtraction levels is the same as that for the addition levels.
3. The subtraction problem corresponding to the addition problem a + b = c is: c − a = b.

TABLE 2
MULTIPLICATION LEVELS

| PROBLEM | L #1 | L #2 | L #3 | L #4 | L #5 | L #6 | L #7 | L #8 | L #9 |
|---|---|---|---|---|---|---|---|---|---|
| 0 × 0 = 0 | 2 | 2 | 1 | 1 | 1 | 2 | 1 | 0 | 1 |
| 0 × 1 = 0 | 1 | 1 | 0 | 0 | 0 | 1 | 1 | 0 | 0 |
| 0 × 2 = 0 | 1 | 1 | 1 | 0 | 0 | 1 | 0 | 0 | 1 |
| 0 × 3 = 0 | 1 | 1 | 0 | 0 | 0 | 1 | 1 | 0 | 0 |
| 0 × 4 = 0 | 1 | 1 | 1 | 0 | 0 | 1 | 0 | 0 | 1 |
| 0 × 5 = 0 | 1 | 1 | 0 | 1 | 0 | 1 | 0 | 0 | 1 |
| 0 × 6 = 0 | 1 | 1 | 1 | 0 | 1 | 1 | 1 | 0 | 0 |
| 0 × 7 = 0 | 1 | 1 | 0 | 0 | 0 | 1 | 1 | 0 | 0 |
| 0 × 8 = 0 | 1 | 1 | 1 | 0 | 0 | 1 | 0 | 0 | 1 |
| 0 × 9 = 0 | 1 | 1 | 0 | 1 | 0 | 1 | 1 | 0 | 1 |
| 1 × 0 = 0 | 1 | 1 | 1 | 0 | 0 | 1 | 0 | 0 | 1 |
| 1 × 1 = 1 | 2 | 2 | 1 | 1 | 1 | 2 | 1 | 0 | 1 |
| 1 × 2 = 2 | 1 | 1 | 0 | 0 | 0 | 1 | 1 | 0 | 0 |
| 1 × 3 = 3 | 1 | 1 | 1 | 0 | 0 | 1 | 1 | 0 | 1 |
| 1 × 4 = 4 | 1 | 1 | 0 | 1 | 1 | 1 | 0 | 0 | 0 |
| 1 × 5 = 5 | 1 | 1 | 1 | 0 | 0 | 1 | 1 | 0 | 1 |
| 1 × 6 = 6 | 1 | 1 | 0 | 0 | 0 | 1 | 1 | 0 | 0 |
| 1 × 7 = 7 | 1 | 1 | 1 | 0 | 0 | 1 | 0 | 0 | 1 |
| 1 × 8 = 8 | 1 | 1 | 0 | 0 | 0 | 1 | 1 | 0 | 0 |
| 1 × 9 = 9 | 1 | 1 | 1 | 0 | 0 | 1 | 1 | 0 | 1 |
| 2 × 0 = 0 | 1 | 1 | 0 | 0 | 0 | 1 | 1 | 0 | 0 |
| 2 × 1 = 2 | 1 | 1 | 1 | 0 | 0 | 1 | 0 | 0 | 1 |
| 2 × 2 = 4 | 15 | 10 | 4 | 2 | 2 | 15 | 4 | 0 | 4 |
| 2 × 3 = 6 | 8 | 5 | 2 | 1 | 1 | 8 | 2 | 0 | 2 |
| 2 × 4 = 8 | 8 | 5 | 2 | 1 | 1 | 8 | 2 | 0 | 2 |
| 2 × 5 = 10 | 8 | 5 | 2 | 1 | 1 | 8 | 2 | 0 | 2 |
| 2 × 6 = 12 | 0 | 15 | 5 | 2 | 1 | 8 | 3 | 0 | 4 |
| 2 × 7 = 14 | 0 | 15 | 5 | 2 | 1 | 8 | 3 | 0 | 4 |
| 2 × 8 = 16 | 0 | 15 | 5 | 2 | 1 | 8 | 3 | 0 | 4 |
| 2 × 9 = 18 | 0 | 15 | 5 | 2 | 1 | 8 | 3 | 0 | 4 |
| 2 × 10 = 20 | 0 | 0 | 2 | 1 | 0 | 1 | 0 | 0 | 0 |
| 2 × 11 = 22 | 0 | 0 | 0 | 0 | 0 | 0 | 0 | 1 | 1 |
| 2 × 12 = 24 | 0 | 0 | 0 | 0 | 0 | 0 | 0 | 4 | 6 |
| 3 × 0 = 0 | 1 | 1 | 1 | 0 | 0 | 1 | 0 | 0 | 1 |
| 3 × 1 = 3 | 1 | 1 | 0 | 0 | 0 | 1 | 0 | 0 | 0 |
| 3 × 2 = 6 | 8 | 5 | 2 | 1 | 1 | 8 | 2 | 0 | 2 |
| 3 × 3 = 9 | 0 | 15 | 8 | 4 | 2 | 15 | 6 | 0 | 8 |
| 3 × 4 = 12 | 0 | 15 | 5 | 2 | 1 | 8 | 3 | 0 | 4 |
| 3 × 5 = 15 | 0 | 15 | 5 | 2 | 1 | 8 | 3 | 0 | 4 |
| 3 × 6 = 18 | 0 | 0 | 15 | 6 | 1 | 8 | 6 | 0 | 6 |
| 3 × 7 = 21 | 0 | 0 | 15 | 6 | 1 | 8 | 6 | 0 | 6 |
| 3 × 8 = 24 | 0 | 0 | 15 | 6 | 2 | 8 | 7 | 0 | 6 |
| 3 × 9 = 27 | 0 | 0 | 15 | 6 | 2 | 8 | 7 | 0 | 6 |
| 3 × 10 = 30 | 0 | 0 | 2 | 1 | 0 | 1 | 0 | 0 | 0 |
| 3 × 11 = 33 | 0 | 0 | 0 | 0 | 0 | 0 | 0 | 1 | 1 |
| 3 × 12 = 36 | 0 | 0 | 0 | 0 | 0 | 0 | 0 | 4 | 6 |
| 4 × 0 = 0 | 1 | 1 | 0 | 0 | 0 | 1 | 1 | 0 | 0 |
| 4 × 1 = 4 | 1 | 1 | 1 | 0 | 0 | 1 | 1 | 0 | 1 |
| 4 × 2 = 8 | 8 | 5 | 2 | 1 | 1 | 8 | 2 | 0 | 2 |
| 4 × 3 = 12 | 0 | 15 | 5 | 2 | 1 | 8 | 3 | 0 | 4 |
| 4 × 4 = 16 | 0 | 15 | 10 | 4 | 3 | 15 | 8 | 0 | 8 |
| 4 × 5 = 20 | 0 | 15 | 5 | 2 | 1 | 8 | 3 | 0 | 4 |
| 4 × 6 = 24 | 0 | 0 | 15 | 6 | 2 | 8 | 7 | 0 | 6 |
| 4 × 7 = 28 | 0 | 0 | 0 | 15 | 3 | 8 | 8 | 0 | 8 |
| 4 × 8 = 32 | 0 | 0 | 0 | 15 | 3 | 8 | 8 | 0 | 8 |
| 4 × 9 = 36 | 0 | 0 | 0 | 15 | 3 | 8 | 8 | 0 | 8 |
| 4 × 10 = 40 | 0 | 0 | 2 | 1 | 0 | 1 | 0 | 0 | 1 |
| 4 × 11 = 44 | 0 | 0 | 0 | 0 | 0 | 0 | 0 | 1 | 1 |
| 4 × 12 = 48 | 0 | 0 | 0 | 0 | 0 | 0 | 0 | 4 | 6 |
| 5 × 0 = 0 | 1 | 1 | 1 | 0 | 0 | 1 | 2 | 0 | 0 |
| 5 × 1 = 5 | 1 | 1 | 0 | 1 | 0 | 1 | 0 | 0 | 0 |
| 5 × 2 = 10 | 8 | 5 | 2 | 1 | 1 | 8 | 2 | 0 | 2 |
| 5 × 3 = 15 | 0 | 15 | 5 | 2 | 1 | 8 | 3 | 0 | 4 |
| 5 × 4 = 20 | 0 | 15 | 5 | 2 | 1 | 8 | 3 | 0 | 4 |
| 5 × 5 = 25 | 0 | 15 | 10 | 4 | 3 | 15 | 9 | 0 | 8 |
| 5 × 6 = 30 | 0 | 0 | 15 | 6 | 1 | 8 | 6 | 0 | 6 |
| 5 × 7 = 35 | 0 | 0 | 0 | 15 | 3 | 8 | 8 | 0 | 8 |
| 5 × 8 = 40 | 0 | 0 | 0 | 15 | 3 | 8 | 8 | 0 | 8 |
| 5 × 9 = 45 | 0 | 0 | 0 | 15 | 3 | 8 | 8 | 0 | 8 |
| 5 × 10 = 50 | 0 | 0 | 2 | 1 | 0 | 1 | 1 | 0 | 0 |
| 5 × 11 = 55 | 0 | 0 | 0 | 0 | 0 | 0 | 0 | 1 | 1 |
| 5 × 12 = 60 | 0 | 0 | 0 | 0 | 0 | 0 | 0 | 6 | 12 |
| 6 × 0 = 0 | 1 | 1 | 0 | 1 | 0 | 1 | 0 | 0 | 1 |
| 6 × 1 = 6 | 1 | 1 | 1 | 0 | 1 | 1 | 1 | 0 | 1 |
| 6 × 2 = 12 | 0 | 15 | 5 | 2 | 1 | 8 | 3 | 0 | 4 |
| 6 × 3 = 18 | 0 | 0 | 15 | 6 | 1 | 8 | 6 | 0 | 6 |
| 6 × 4 = 24 | 0 | 0 | 15 | 6 | 2 | 8 | 7 | 0 | 6 |
| 6 × 5 = 30 | 0 | 0 | 15 | 6 | 1 | 8 | 6 | 0 | 6 |
| 6 × 6 = 36 | 0 | 0 | 15 | 12 | 4 | 15 | 15 | 0 | 12 |
| 6 × 7 = 42 | 0 | 0 | 0 | 0 | 15 | 15 | 13 | 0 | 12 |
| 6 × 8 = 48 | 0 | 0 | 0 | 0 | 15 | 15 | 13 | 0 | 12 |
| 6 × 9 = 54 | 0 | 0 | 0 | 0 | 15 | 15 | 13 | 0 | 12 |
| 6 × 10 = 60 | 0 | 0 | 2 | 1 | 1 | 1 | 0 | 0 | 1 |
| 6 × 11 = 66 | 0 | 0 | 0 | 0 | 0 | 0 | 0 | 1 | 1 |
| 6 × 12 = 72 | 0 | 0 | 0 | 0 | 0 | 0 | 0 | 6 | 12 |
| 7 × 0 = 0 | 1 | 1 | 1 | 0 | 0 | 1 | 0 | 0 | 1 |
| 7 × 1 = 7 | 1 | 1 | 0 | 1 | 0 | 1 | 1 | 0 | 1 |
| 7 × 2 = 14 | 0 | 15 | 5 | 2 | 1 | 8 | 3 | 0 | 4 |
| 7 × 3 = 21 | 0 | 0 | 15 | 6 | 1 | 8 | 6 | 0 | 6 |
| 7 × 4 = 28 | 0 | 0 | 0 | 15 | 3 | 8 | 8 | 0 | 8 |
| 7 × 5 = 35 | 0 | 0 | 0 | 15 | 3 | 8 | 8 | 0 | 8 |
| 7 × 6 = 42 | 0 | 0 | 0 | 0 | 15 | 15 | 13 | 0 | 12 |
| 7 × 7 = 49 | 0 | 0 | 0 | 0 | 15 | 15 | 15 | 0 | 15 |
| 7 × 8 = 56 | 0 | 0 | 0 | 0 | 15 | 15 | 13 | 0 | 12 |
| 7 × 9 = 63 | 0 | 0 | 0 | 0 | 15 | 15 | 13 | 0 | 12 |
| 7 × 10 = 70 | 0 | 0 | 2 | 1 | 0 | 1 | 1 | 0 | 0 |
| 7 × 11 = 77 | 0 | 0 | 0 | 0 | 0 | 0 | 0 | 1 | 1 |
| 7 × 12 = 84 | 0 | 0 | 0 | 0 | 0 | 0 | 0 | 6 | 12 |
| 8 × 0 = 0 | 1 | 1 | 0 | 0 | 0 | 1 | 1 | 0 | 0 |
| 8 × 1 = 8 | 1 | 1 | 1 | 0 | 0 | 1 | 1 | 0 | 1 |
| 8 × 2 = 16 | 0 | 15 | 5 | 2 | 1 | 8 | 3 | 0 | 4 |
| 8 × 3 = 24 | 0 | 0 | 15 | 6 | 2 | 8 | 7 | 0 | 6 |
| 8 × 4 = 32 | 0 | 0 | 0 | 15 | 3 | 8 | 8 | 0 | 8 |
| 8 × 5 = 40 | 0 | 0 | 0 | 15 | 3 | 8 | 8 | 0 | 8 |
| 8 × 6 = 48 | 0 | 0 | 0 | 0 | 15 | 15 | 13 | 0 | 12 |
| 8 × 7 = 56 | 0 | 0 | 0 | 0 | 15 | 15 | 13 | 0 | 12 |
| 8 × 8 = 64 | 0 | 0 | 0 | 0 | 15 | 15 | 15 | 0 | 15 |
| 8 × 9 = 72 | 0 | 0 | 0 | 0 | 15 | 15 | 13 | 0 | 12 |
| 8 × 10 = 80 | 0 | 0 | 2 | 1 | 1 | 1 | 0 | 0 | 1 |
| 8 × 11 = 88 | 0 | 0 | 0 | 0 | 0 | 0 | 0 | 1 | 1 |
| 8 × 12 = 96 | 0 | 0 | 0 | 0 | 0 | 0 | 0 | 6 | 12 |
| 9 × 0 = 0 | 1 | 1 | 1 | 0 | 1 | 1 | 1 | 0 | 1 |
| 9 × 1 = 9 | 1 | 1 | 0 | 0 | 0 | 1 | 1 | 0 | 0 |
| 9 × 2 = 18 | 0 | 15 | 5 | 2 | 1 | 8 | 3 | 0 | 4 |
| 9 × 3 = 27 | 0 | 0 | 15 | 6 | 2 | 8 | 7 | 0 | 6 |
| 9 × 4 = 36 | 0 | 0 | 0 | 15 | 3 | 8 | 8 | 0 | 8 |
| 9 × 5 = 45 | 0 | 0 | 0 | 15 | 3 | 8 | 8 | 0 | 8 |
| 9 × 6 = 54 | 0 | 0 | 0 | 0 | 15 | 15 | 13 | 0 | 12 |
| 9 × 7 = 63 | 0 | 0 | 0 | 0 | 15 | 15 | 13 | 0 | 12 |
| 9 × 8 = 72 | 0 | 0 | 0 | 0 | 15 | 15 | 13 | 0 | 12 |
| 9 × 9 = 81 | 0 | 0 | 0 | 0 | 15 | 15 | 15 | 0 | 15 |
| 9 × 10 = 90 | 0 | 0 | 2 | 1 | 0 | 1 | 1 | 0 | 0 |
| 9 × 11 = 99 | 0 | 0 | 0 | 0 | 0 | 0 | 0 | 1 | 1 |
| 9 × 12 = 108 | 0 | 0 | 0 | 0 | 0 | 0 | 0 | 12 | 15 |
| 10 × 2 = 20 | 0 | 0 | 2 | 1 | 0 | 1 | 0 | 0 | 0 |
| 10 × 3 = 30 | 0 | 0 | 2 | 1 | 1 | 1 | 0 | 0 | 0 |
| 10 × 4 = 40 | 0 | 0 | 2 | 1 | 0 | 1 | 1 | 0 | 0 |
| 10 × 5 = 50 | 0 | 0 | 2 | 1 | 0 | 1 | 0 | 0 | 1 |
| 10 × 6 = 60 | 0 | 0 | 2 | 1 | 0 | 1 | 1 | 0 | 0 |
| 10 × 7 = 70 | 0 | 0 | 2 | 1 | 0 | 1 | 0 | 0 | 1 |
| 10 × 8 = 80 | 0 | 0 | 2 | 1 | 0 | 1 | 1 | 0 | 0 |
| 10 × 9 = 90 | 0 | 0 | 2 | 1 | 1 | 1 | 0 | 0 | 1 |
| 10 × 10 = 100 | 0 | 0 | 15 | 12 | 2 | 15 | 12 | 0 | 12 |
| 10 × 11 = 110 | 0 | 0 | 0 | 0 | 0 | 0 | 0 | 6 | 12 |
| 10 × 12 = 120 | 0 | 0 | 0 | 0 | 0 | 0 | 0 | 6 | 12 |
| 11 × 2 = 22 | 0 | 0 | 0 | 0 | 0 | 0 | 0 | 1 | 1 |
| 11 × 3 = 33 | 0 | 0 | 0 | 0 | 0 | 0 | 0 | 1 | 1 |
| 11 × 4 = 44 | 0 | 0 | 0 | 0 | 0 | 0 | 0 | 1 | 1 |
| 11 × 5 = 55 | 0 | 0 | 0 | 0 | 0 | 0 | 0 | 1 | 1 |
| 11 × 6 = 66 | 0 | 0 | 0 | 0 | 0 | 0 | 0 | 1 | 1 |
| 11 × 7 = 77 | 0 | 0 | 0 | 0 | 0 | 0 | 0 | 1 | 1 |
| 11 × 8 = 88 | 0 | 0 | 0 | 0 | 0 | 0 | 0 | 1 | 1 |
| 11 × 9 = 99 | 0 | 0 | 0 | 0 | 0 | 0 | 0 | 1 | 1 |
| 11 × 10 = 110 | 0 | 0 | 0 | 0 | 0 | 0 | 0 | 6 | 12 |
| 11 × 11 = 121 | 0 | 0 | 0 | 0 | 0 | 0 | 0 | 15 | 15 |
| 11 × 12 = 132 | 0 | 0 | 0 | 0 | 0 | 0 | 0 | 12 | 15 |
| 12 × 2 = 24 | 0 | 0 | 0 | 0 | 0 | 0 | 0 | 4 | 6 |
| 12 × 3 = 36 | 0 | 0 | 0 | 0 | 0 | 0 | 0 | 4 | 6 |
| 12 × 4 = 48 | 0 | 0 | 0 | 0 | 0 | 0 | 0 | 4 | 6 |
| 12 × 5 = 60 | 0 | 0 | 0 | 0 | 0 | 0 | 0 | 6 | 12 |
| 12 × 6 = 72 | 0 | 0 | 0 | 0 | 0 | 0 | 0 | 6 | 12 |
| 12 × 7 = 84 | 0 | 0 | 0 | 0 | 0 | 0 | 0 | 6 | 12 |
| 12 × 8 = 96 | 0 | 0 | 0 | 0 | 0 | 0 | 0 | 6 | 12 |
| 12 × 9 = 108 | 0 | 0 | 0 | 0 | 0 | 0 | 0 | 12 | 15 |
| 12 × 10 = 120 | 0 | 0 | 0 | 0 | 0 | 0 | 0 | 6 | 12 |
| 12 × 11 = 132 | 0 | 0 | 0 | 0 | 0 | 0 | 0 | 12 | 15 |
| 12 × 12 = 144 | 0 | 0 | 0 | 0 | 0 | 0 | 0 | 15 | 15 |
| | 101 | 333 | 375 | 348 | 325 | 721 | 513 | 190 | 790 |

Explanatory Note:
“L” = “Level”. The columns labeled “L #[number]” show the relative frequency of each problem in the enumerated level. Problem frequency is rated from 0 to 15. For example, a problem rated 15, on average, is presented 15 times as often as a problem rated 1 and three times as often as a problem rated 5. A problem rated 0 is not included in the level in question.

TABLE 3
DIVISION LEVELS

| PROBLEM | L #1 | L #2 | L #3 | L #4 | L #5 | L #6 | L #7 | L #8 | L #9 |
|---|---|---|---|---|---|---|---|---|---|
| 0/1 = 0 | 1 | 1 | 1 | 0 | 0 | 1 | 1 | 0 | 1 |
| 1/1 = 1 | 2 | 2 | 1 | 1 | 1 | 2 | 1 | 0 | 1 |
| 2/1 = 2 | 1 | 1 | 0 | 0 | 0 | 1 | 0 | 0 | 1 |
| 3/1 = 3 | 1 | 1 | 1 | 0 | 0 | 1 | 1 | 0 | 1 |
| 4/1 = 4 | 1 | 1 | 0 | 1 | 1 | 1 | 1 | 0 | 0 |
| 5/1 = 5 | 1 | 1 | 1 | 0 | 0 | 1 | 0 | 0 | 1 |
| 6/1 = 6 | 1 | 1 | 0 | 0 | 0 | 1 | 1 | 0 | 0 |
| 7/1 = 7 | 1 | 1 | 1 | 0 | 0 | 1 | 1 | 0 | 1 |
| 8/1 = 8 | 1 | 1 | 0 | 0 | 0 | 1 | 1 | 0 | 1 |
| 9/1 = 9 | 1 | 1 | 1 | 0 | 0 | 1 | 0 | 0 | 1 |
| 0/2 = 0 | 1 | 1 | 0 | 0 | 0 | 1 | 1 | 0 | 1 |
| 2/2 = 1 | 1 | 1 | 1 | 0 | 0 | 1 | 1 | 0 | 0 |
| 4/2 = 2 | 15 | 10 | 4 | 2 | 2 | 15 | 4 | 0 | 4 |
| 6/2 = 3 | 8 | 5 | 2 | 1 | 1 | 8 | 2 | 0 | 2 |
| 8/2 = 4 | 8 | 5 | 2 | 1 | 1 | 8 | 2 | 0 | 2 |
| 10/2 = 5 | 8 | 5 | 2 | 1 | 1 | 8 | 2 | 0 | 2 |
| 12/2 = 6 | 0 | 15 | 5 | 2 | 1 | 8 | 3 | 0 | 4 |
| 14/2 = 7 | 0 | 15 | 5 | 2 | 1 | 8 | 3 | 0 | 4 |
| 16/2 = 8 | 0 | 15 | 5 | 2 | 1 | 8 | 3 | 0 | 4 |
| 18/2 = 9 | 0 | 15 | 5 | 2 | 1 | 8 | 3 | 0 | 4 |
| 20/2 = 10 | 0 | 0 | 2 | 1 | 0 | 1 | 0 | 0 | 0 |
| 22/2 = 11 | 0 | 0 | 0 | 0 | 0 | 0 | 0 | 1 | 1 |
| 24/2 = 12 | 0 | 0 | 0 | 0 | 0 | 0 | 0 | 4 | 6 |
| 0/3 = 0 | 1 | 1 | 1 | 0 | 0 | 1 | 1 | 0 | 1 |
| 3/3 = 1 | 1 | 1 | 0 | 0 | 0 | 1 | 0 | 0 | 1 |
| 6/3 = 2 | 8 | 5 | 2 | 1 | 1 | 8 | 2 | 0 | 2 |
| 9/3 = 3 | 0 | 15 | 8 | 4 | 2 | 15 | 6 | 0 | 8 |
| 12/3 = 4 | 0 | 15 | 5 | 2 | 1 | 8 | 3 | 0 | 4 |
| 15/3 = 5 | 0 | 15 | 5 | 2 | 1 | 8 | 3 | 0 | 4 |
| 18/3 = 6 | 0 | 0 | 15 | 6 | 1 | 8 | 6 | 0 | 6 |
| 21/3 = 7 | 0 | 0 | 15 | 6 | 1 | 8 | 6 | 0 | 6 |
| 24/3 = 8 | 0 | 0 | 15 | 6 | 2 | 8 | 7 | 0 | 6 |
| 27/3 = 9 | 0 | 0 | 15 | 6 | 2 | 8 | 7 | 0 | 6 |
| 30/3 = 10 | 0 | 0 | 2 | 1 | 0 | 1 | 0 | 0 | 0 |
| 33/3 = 11 | 0 | 0 | 0 | 0 | 0 | 0 | 0 | 1 | 1 |
| 36/3 = 12 | 0 | 0 | 0 | 0 | 0 | 0 | 0 | 4 | 6 |
| 0/4 = 0 | 1 | 1 | 0 | 0 | 0 | 1 | 1 | 0 | 1 |
| 4/4 = 1 | 1 | 1 | 1 | 0 | 0 | 1 | 0 | 0 | 1 |
| 8/4 = 2 | 8 | 5 | 2 | 1 | 1 | 8 | 2 | 0 | 2 |
| 12/4 = 3 | 0 | 15 | 5 | 2 | 1 | 8 | 3 | 0 | 4 |
| 16/4 = 4 | 0 | 15 | 10 | 4 | 3 | 15 | 8 | 0 | 8 |
| 20/4 = 5 | 0 | 15 | 5 | 2 | 1 | 8 | 3 | 0 | 4 |
| 24/4 = 6 | 0 | 0 | 15 | 6 | 2 | 8 | 7 | 0 | 6 |
| 28/4 = 7 | 0 | 0 | 0 | 15 | 3 | 8 | 8 | 0 | 8 |
| 32/4 = 8 | 0 | 0 | 0 | 15 | 3 | 8 | 8 | 0 | 8 |
| 36/4 = 9 | 0 | 0 | 0 | 15 | 3 | 8 | 8 | 0 | 8 |
| 40/4 = 10 | 0 | 0 | 2 | 1 | 0 | 1 | 0 | 0 | 1 |
| 44/4 = 11 | 0 | 0 | 0 | 0 | 0 | 0 | 0 | 1 | 1 |
| 48/4 = 12 | 0 | 0 | 0 | 0 | 0 | 0 | 0 | 4 | 6 |
| 0/5 = 0 | 1 | 1 | 1 | 0 | 0 | 1 | 1 | 0 | 1 |
| 5/5 = 1 | 1 | 1 | 0 | 1 | 0 | 1 | 1 | 0 | 0 |
| 10/5 = 2 | 8 | 5 | 2 | 1 | 1 | 8 | 2 | 0 | 2 |
| 15/5 = 3 | 0 | 15 | 5 | 2 | 1 | 8 | 3 | 0 | 4 |
| 20/5 = 4 | 0 | 15 | 5 | 2 | 1 | 8 | 3 | 0 | 4 |
| 25/5 = 5 | 0 | 15 | 10 | 4 | 3 | 15 | 9 | 0 | 8 |
| 30/5 = 6 | 0 | 0 | 15 | 6 | 1 | 8 | 6 | 0 | 6 |
| 35/5 = 7 | 0 | 0 | 0 | 15 | 3 | 8 | 8 | 0 | 8 |
| 40/5 = 8 | 0 | 0 | 0 | 15 | 3 | 8 | 8 | 0 | 8 |
| 45/5 = 9 | 0 | 0 | 0 | 15 | 3 | 8 | 8 | 0 | 8 |
| 50/5 = 10 | 0 | 0 | 2 | 1 | 0 | 1 | 1 | 0 | 0 |
| 55/5 = 11 | 0 | 0 | 0 | 0 | 0 | 0 | 0 | 1 | 1 |
| 60/5 = 12 | 0 | 0 | 0 | 0 | 0 | 0 | 0 | 6 | 12 |
| 0/6 = 0 | 1 | 1 | 0 | 1 | 0 | 1 | 1 | 0 | 1 |
| 6/6 = 1 | 1 | 1 | 1 | 0 | 1 | 1 | 0 | 0 | 1 |
| 12/6 = 2 | 0 | 15 | 5 | 2 | 1 | 8 | 3 | 0 | 4 |
| 18/6 = 3 | 0 | 0 | 15 | 6 | 1 | 8 | 6 | 0 | 6 |
| 24/6 = 4 | 0 | 0 | 15 | 6 | 2 | 8 | 7 | 0 | 6 |
| 30/6 = 5 | 0 | 0 | 15 | 6 | 1 | 8 | 6 | 0 | 6 |
| 36/6 = 6 | 0 | 0 | 15 | 12 | 4 | 15 | 15 | 0 | 12 |
| 42/6 = 7 | 0 | 0 | 0 | 0 | 15 | 15 | 13 | 0 | 12 |
| 48/6 = 8 | 0 | 0 | 0 | 0 | 15 | 15 | 13 | 0 | 12 |
| 54/6 = 9 | 0 | 0 | 0 | 0 | 15 | 15 | 13 | 0 | 12 |
| 60/6 = 10 | 0 | 0 | 2 | 1 | 1 | 1 | 0 | 0 | 1 |
| 66/6 = 11 | 0 | 0 | 0 | 0 | 0 | 0 | 0 | 1 | 1 |
| 72/6 = 12 | 0 | 0 | 0 | 0 | 0 | 0 | 0 | 6 | 12 |
| 0/7 = 0 | 1 | 1 | 1 | 0 | 0 | 1 | 1 | 0 | 1 |
| 7/7 = 1 | 1 | 1 | 0 | 1 | 0 | 1 | 1 | 0 | 0 |
| 14/7 = 2 | 0 | 15 | 5 | 2 | 1 | 8 | 3 | 0 | 4 |
| 21/7 = 3 | 0 | 0 | 15 | 6 | 1 | 8 | 6 | 0 | 6 |
| 28/7 = 4 | 0 | 0 | 0 | 15 | 3 | 8 | 8 | 0 | 8 |
| 35/7 = 5 | 0 | 0 | 0 | 15 | 3 | 8 | 8 | 0 | 8 |
| 42/7 = 6 | 0 | 0 | 0 | 0 | 15 | 15 | 13 | 0 | 12 |
| 49/7 = 7 | 0 | 0 | 0 | 0 | 15 | 15 | 15 | 0 | 15 |
| 56/7 = 8 | 0 | 0 | 0 | 0 | 15 | 15 | 13 | 0 | 12 |
| 63/7 = 9 | 0 | 0 | 0 | 0 | 15 | 15 | 13 | 0 | 12 |
| 70/7 = 10 | 0 | 0 | 2 | 1 | 0 | 1 | 1 | 0 | 0 |
| 77/7 = 11 | 0 | 0 | 0 | 0 | 0 | 0 | 0 | 1 | 1 |
| 84/7 = 12 | 0 | 0 | 0 | 0 | 0 | 0 | 0 | 6 | 12 |
| 0/8 = 0 | 1 | 1 | 0 | 0 | 0 | 1 | 1 | 0 | 1 |
| 8/8 = 1 | 1 | 1 | 1 | 0 | 0 | 1 | 1 | 0 | 1 |
| 16/8 = 2 | 0 | 15 | 5 | 2 | 1 | 8 | 3 | 0 | 4 |
| 24/8 = 3 | 0 | 0 | 15 | 6 | 2 | 8 | 7 | 0 | 6 |
| 32/8 = 4 | 0 | 0 | 0 | 15 | 3 | 8 | 8 | 0 | 8 |
| 40/8 = 5 | 0 | 0 | 0 | 15 | 3 | 8 | 8 | 0 | 8 |
| 45/8 = 6 | 0 | 0 | 0 | 0 | 15 | 15 | 13 | 0 | 12 |
| 56/8 = 7 | 0 | 0 | 0 | 0 | 15 | 15 | 13 | 0 | 12 |
| 64/8 = 8 | 0 | 0 | 0 | 0 | 15 | 15 | 15 | 0 | 15 |
| 72/8 = 9 | 0 | 0 | 0 | 0 | 15 | 15 | 13 | 0 | 12 |
| 80/8 = 10 | 0 | 0 | 2 | 1 | 1 | 1 | 0 | 0 | 1 |
| 88/8 = 11 | 0 | 0 | 0 | 0 | 0 | 0 | 0 | 1 | 1 |
| 96/8 = 12 | 0 | 0 | 0 | 0 | 0 | 0 | 0 | 6 | 12 |
| 0/9 = 0 | 1 | 1 | 1 | 0 | 1 | 1 | 1 | 0 | 1 |
| 9/9 = 1 | 1 | 1 | 0 | 0 | 0 | 1 | 1 | 0 | 1 |
| 18/9 = 2 | 0 | 15 | 5 | 2 | 1 | 8 | 3 | 0 | 4 |
| 27/9 = 3 | 0 | 0 | 15 | 6 | 2 | 8 | 7 | 0 | 6 |
| 36/9 = 4 | 0 | 0 | 0 | 15 | 3 | 8 | 8 | 0 | 8 |
| 45/9 = 5 | 0 | 0 | 0 | 15 | 3 | 8 | 8 | 0 | 8 |
| 54/9 = 6 | 0 | 0 | 0 | 0 | 15 | 15 | 13 | 0 | 12 |
| 63/9 = 7 | 0 | 0 | 0 | 0 | 15 | 15 | 13 | 0 | 12 |
| 72/9 = 8 | 0 | 0 | 0 | 0 | 15 | 15 | 13 | 0 | 12 |
| 81/9 = 9 | 0 | 0 | 0 | 0 | 15 | 15 | 15 | 0 | 15 |
| 90/9 = 10 | 0 | 0 | 2 | 1 | 0 | 1 | 1 | 0 | 0 |
| 99/9 = 11 | 0 | 0 | 0 | 0 | 0 | 0 | 0 | 1 | 1 |
| 108/9 = 12 | 0 | 0 | 0 | 0 | 0 | 0 | 0 | 12 | 15 |
| 20/10 = 2 | 0 | 0 | 2 | 1 | 0 | 1 | 0 | 0 | 0 |
| 30/10 = 3 | 0 | 0 | 2 | 1 | 1 | 1 | 0 | 0 | 0 |
| 40/10 = 4 | 0 | 0 | 2 | 1 | 0 | 1 | 1 | 0 | 0 |
| 50/10 = 5 | 0 | 0 | 2 | 1 | 0 | 1 | 0 | 0 | 1 |
| 60/10 = 6 | 0 | 0 | 2 | 1 | 0 | 1 | 1 | 0 | 0 |
| 70/10 = 7 | 0 | 0 | 2 | 1 | 0 | 1 | 0 | 0 | 1 |
| 80/10 = 8 | 0 | 0 | 2 | 1 | 0 | 1 | 1 | 0 | 0 |
| 90/10 = 9 | 0 | 0 | 2 | 1 | 1 | 1 | 0 | 0 | 1 |
| 100/10 = 10 | 0 | 0 | 15 | 12 | 2 | 15 | 12 | 0 | 12 |
| 110/10 = 11 | 0 | 0 | 0 | 0 | 0 | 0 | 0 | 6 | 12 |
| 120/10 = 12 | 0 | 0 | 0 | 0 | 0 | 0 | 0 | 6 | 12 |
| 22/11 = 2 | 0 | 0 | 0 | 0 | 0 | 0 | 0 | 1 | 1 |
| 33/11 = 3 | 0 | 0 | 0 | 0 | 0 | 0 | 0 | 1 | 1 |
| 44/11 = 4 | 0 | 0 | 0 | 0 | 0 | 0 | 0 | 1 | 1 |
| 55/11 = 5 | 0 | 0 | 0 | 0 | 0 | 0 | 0 | 1 | 1 |
| 66/11 = 6 | 0 | 0 | 0 | 0 | 0 | 0 | 0 | 1 | 1 |
| 77/11 = 7 | 0 | 0 | 0 | 0 | 0 | 0 | 0 | 1 | 1 |
| 88/11 = 8 | 0 | 0 | 0 | 0 | 0 | 0 | 0 | 1 | 1 |
| 99/11 = 9 | 0 | 0 | 0 | 0 | 0 | 0 | 0 | 1 | 1 |
| 110/11 = 10 | 0 | 0 | 0 | 0 | 0 | 0 | 0 | 6 | 12 |
| 121/11 = 11 | 0 | 0 | 0 | 0 | 0 | 0 | 0 | 15 | 15 |
| 132/11 = 12 | 0 | 0 | 0 | 0 | 0 | 0 | 0 | 12 | 15 |
| 24/12 = 2 | 0 | 0 | 0 | 0 | 0 | 0 | 0 | 4 | 6 |
| 36/12 = 3 | 0 | 0 | 0 | 0 | 0 | 0 | 0 | 4 | 6 |
| 48/12 = 4 | 0 | 0 | 0 | 0 | 0 | 0 | 0 | 4 | 6 |
| 60/12 = 5 | 0 | 0 | 0 | 0 | 0 | 0 | 0 | 6 | 12 |
| 72/12 = 6 | 0 | 0 | 0 | 0 | 0 | 0 | 0 | 6 | 12 |
| 84/12 = 7 | 0 | 0 | 0 | 0 | 0 | 0 | 0 | 6 | 12 |
| 96/12 = 8 | 0 | 0 | 0 | 0 | 0 | 0 | 0 | 6 | 12 |
| 108/12 = 9 | 0 | 0 | 0 | 0 | 0 | 0 | 0 | 12 | 15 |
| 120/12 = 10 | 0 | 0 | 0 | 0 | 0 | 0 | 0 | 6 | 12 |
| 132/12 = 11 | 0 | 0 | 0 | 0 | 0 | 0 | 0 | 12 | 15 |
| 144/12 = 12 | 0 | 0 | 0 | 0 | 0 | 0 | 0 | 15 | 15 |
| | 90 | 322 | 370 | 345 | 323 | 710 | 509 | 190 | 790 |

Explanatory Note:
“L” = “Level”. The columns labeled “L #[number]” show the relative frequency of each problem in the enumerated level. Problem frequency is rated from 0 to 15. For example, a problem rated 15, on average, is presented 15 times as often as a problem rated 1 and three times as often as a problem rated 5. A problem rated 0 is not included in the level in question.

Level 7 is the default level of difficulty. Thus, when the learning aid is turned from OFF to ON, level 7 applies and the probabilities for that level from the tables above apply.

The level number can be changed by pushing LEVEL # OR TABLE # key 21, but only when LEVEL flag 49 is currently displayed, in which case a single-digit level number is also displayed to the right of that flag. (FIG. 2) Under these circumstances, pushing the LEVEL # OR TABLE # key increases the currently-displayed level number (which is not necessarily the last-selected level number) by one unless it has reached 9, in which case it changes to 1. If the LEVEL # OR TABLE # key is pushed while the Practice, Test or Flashcards activity is in progress, not only does the currently-displayed level number change, but also the learning aid poises itself for that particular activity in the currently-displayed arithmetic operation and with the last-selected time limit. If the LEVEL # OR TABLE # key is pushed while the results of a Practice, Test or Flashcards activity are being displayed, the currently-displayed level number changes, and the learning aid poises itself for that particular activity in the currently-displayed arithmetic operation but with the lowest time limit that equals or exceeds the currently-displayed time limit.

The Term “Inert”

The term “inert” is used to describe a key that, under current circumstances, is basically non-functional. The qualifier “basically” is used in the preceding sentence for two reasons. First, except in the case of the six learning activity keys and in the case of number keys when right-side CORRECT flag 63 is displayed when a learning activity is in progress: when the learning aid is ON and sound is not switched to OFF, the pushing of a key that is currently inert results in the emission of the negative tones to inform the user that an inappropriate key has been pushed. Second, the pushing of any key, functional or inert, immediately interrupts and terminates the emission of any sound effect that is in the process of being emitted.

Practice Learning Activity

If the learning aid is ON but not already poised for the Practice learning activity, pushing PRACTICE key 13 so poises it. (If the learning aid is already poised for the Practice learning activity, the PRACTICE key is inert, and pushing it has no effect, not even the generation of the negative tones.) As a result, PRACTICE flag 33 is displayed. Then the user is able to adjust: (1) the per-activity (as opposed to per-problem) time limit by pushing TIME LIMIT key 19 one or more times until the desired number of seconds—180, 150, 120, 90, 75, 60, 45, or 30—is displayed in the upper left corner of display 11 to the left of a displayed SECONDS flag 51; (2) the arithmetic operation by pushing +−×÷ key 20 one or more times until the appropriate operation symbol is displayed between S3 and S4; and (3) the level of difficulty by pushing LEVEL # OR TABLE # key 21 one or more times until the appropriate number is displayed to the right of also-displayed LEVEL flag 49. At this point, pushing START key 22 begins the almost random presentation of the designated group of problems for the designated period of time.

Correct and incorrect answers are treated the same way in a Practice learning activity as in a Table-No-Order learning activity except that: (1) correct answers and right-side CORRECT flag 63 remain displayed for only 0.9 second (unless modified as explained below); and (2) after two consecutive incorrect answers, the correct answer is displayed (as a prompt) for only 2.2 seconds (unless modified as explained below).

In the Practice activity, as in the other activities that are subject to a per-activity time limit, the time limit continues to expire throughout the learning aid's responses to correct and incorrect answers. As in the case of the Table activities, upon the completion of the Practice activity, the learning aid emits a pleasant-sounding multi-tone sound effect and simultaneously displays: (1) above displayed horizontal lines and the appropriate displayed flags: (a) the number of all problems answered correctly; (b) the number of all problems attempted; and (c) the percentage of problems answered correctly, rounded to the nearest percent; (2) large % flag 64; and (3) blinking WOW!! flag 56 if that percentage equals 100% and at least 20 problems have been attempted. Also displayed are: (1) PRACTICE flag 33; (2) RESULT flag 46 followed by a number from 1 to 9 corresponding to the number of learning-activity results currently stored in memory, including this most recent result; (3) the symbol for the arithmetic operation that was in effect; (4) SECONDS flag 51 and to its left the number of elapsed seconds; (5) LEVEL flag 49; and (6) to its right, the number of the level that was in effect.

When the Practice learning activity is in progress, the user can stop the running of the timer by pushing PAUSE key 25—thereby pausing the Practice learning activity and causing a PAUSED flag 52 to blink—and then restart the running of the time limit—thereby extinguishing the PAUSED flag—either by pushing START key 22 or by pushing PAUSE key 25 again. The PAUSE key pauses only the Practice learning activity and the Special Problems learning activity (discussed below).

Test Learning Activity

There are six important differences between the Test learning activity and the Practice learning activity.

First, obviously, pushing TEST key 14, not key 13, poises the learning aid for the Test learning activity, as shown by the illumination of TEST flag 34, not flag 33.

Second, in the Test activity, correct and incorrect answers are displayed for only 0.3 second (unless modified as discussed below) before the presentation of the next problem.

Third, in the Test activity correct answers do not result in the illumination of right-side CORRECT flag 63, and incorrect answers do not result in the display of NOT flag 61 or flag 63. As in the Practice activity, correct and incorrect answers do result in positive and negative sound effects although these sound effects can be eliminated by sliding switch 23 to the OFF position.

Fourth, in the Test activity, incorrectly answered problems are not re-presented for another try—neither immediately after the initial mistake nor after the presentation of a different problem.

Fifth, PAUSE key 25 is inert during a Test learning activity.

Sixth, in the Test learning activity, by designating the same problem format (e.g., 1+2=?), time limit, arithmetic operation, and level and pushing the same one of number keys 12 prior to starting the Test learning activity, two or more users can take the same test, i.e., the same problems in the same order subject to the same time limit. (It is also assumed here that in each case the learning aid is set for the same “Relative Length of Prompts”. See discussion below.) The pushing of the one-digit number results in: (1) the setting of the learning aid to run a specific sequence of problems corresponding to the particular number and the selected level; (2) the emission of a ding sound; and (3) the illumination of that number (i.e., 0-9) immediately to the right of undisplayed TABLE: flag 36. (FIG. 2)

Unless changed or cleared (as explained below), that number (sequence number) is displayed while the learning aid is poised for the Test activity, while the Test activity is in progress, and whenever the results of the Test activity are being displayed. Pushing a different one of number keys 12 while the learning aid remains poised for the Test activity results in: (1) the poising of the learning aid to run a different specific sequence of problems corresponding to the different sequence number; (2) the emission of a ding sound; and (3) the illumination of the new sequence number. On the other hand, a sequence number is eliminated by pushing: any learning activity key, including TEST key 14; ENTER PROBLEMS key 28 (discussed below); ON/OFF key 24; and SEE RESULTS key 29 (although a sequence number cleared by the pushing of key 29 while a Test activity is in progress is recorded and accordingly displayed with the results of the interrupted Test activity). In addition, unless the learning aid is poised for the Test (or Flashcards (see below)) activity, a sequence number is eliminated by pushing: START key 22, TIME LIMIT key 19, +−×÷ key 20, LEVEL ft OR TABLE # key 21, PROBLEM FORMAT key 31, HIDE OR SHOW COUNTDOWN key 26 (see below), ERASE RESULTS key 30 (see below), or ERASE MISSED OR ENTERED PROBLEMS key 27 (see below).

The result of a Test learning activity is displayed simultaneously with the emission of the pleasant-sounding multi-tone sound effect and in essentially the same fashion as the result of a Practice activity. If a problem sequence number was in effect during the activity, it is displayed in the usual location. Of course, TEST flag 34 is displayed instead of PRACTICE flag 33.

Flashcards Learning Activity

The user operates the Flashcards learning activity by following Steps #1 through #6 described above under “Overview of Operation of Learning Activities”. A per-activity time limit (e.g., 180 seconds) does not apply to the Flashcards activity; rather a per-problem time limit applies. As Step #2, the user selects the desired per-problem time limit by pushing TIME LIMIT key 19 zero or more times until the desired time limit is displayed to the left of displayed SECONDS flag 51. The possible per-problem time limits are: 9 seconds, 7 seconds, 5 seconds, 4 seconds, 3 seconds, 2.5 seconds, 2.0 seconds, 1.6 seconds, 1.3 seconds, and 1.0 second

For purposes of this activity, to display the time limit, display 11 uses a units column and a tenths column, as opposed to the hundreds, tens, and units columns used by it for the purposes of the Practice, Test, and Special Problems activities. A decimal point is displayed between the units and tenths columns. (FIG. 2) There is one exception, however, to the preceding two sentences: when the selected time limit is 3 seconds or greater (i.e., 9, 7, 5, 4, or 3 seconds), the decimal and the number in the tenths column are never displayed even when the time limit counts down below 3 seconds. (The decreasing time limit is displayed in the space immediately to the left of the undisplayed decimal.) By contrast, the decimal and the number in the tenths column are always displayed for the shorter time limits (i.e., 2.5, 2.0, 1.6, 1.3, 1.0), even when 2.0 or 1.0 is being displayed with the results of a Flashcards activity.

In the Flashcards learning activity, upon the pressing of the START key, the learning aid normally presents to the user 50 problems of the kind designated by the user prior to pressing that key and a 50 is displayed to the left of FLASHCARDS flag 35 (FIG. 2) when the learning aid is poised for the activity or the activity is in progress, but not when the results of a Flashcards activity are being displayed. In the manner described below, the user is able to adjust the learning aid so that 80, 70, 60, 40, 30, 20, or 10 problems are presented instead of 50, in which event that number is displayed instead of 50 when and where 50 would otherwise be displayed. Whenever the learning aid is turned OFF, however, it reverts to the number 50.

To answer a problem correctly in the Flashcards activity, the user is required not only to type the appropriate response to the problem but also to do so within the designated per-problem time limit. The activity continues until the user has had an opportunity to answer all 50 problems (unless a different number has been designated, as explained below). When the Flashcards learning activity does end, results of the activity are displayed essentially as in a Test activity except that the FLASHCARDS flag—but not, to its left, the number of problems that the user was supposed to answer—is displayed instead of the TEST flag and the per-problem time limit used during the Flashcards activity is displayed instead of a per-activity time limit.

In the Flashcards activity, the failure to enter completely a correct answer within the per-problem time limit is treated as an incorrect answer, but contrast clauses (3) and (4) in the following sentence. Correct and incorrect answers are treated as in the Practice activity, except: (1) in the Flashcards activity, incorrectly answered problems are not re-presented to the user for another try-neither immediately after the initial mistake nor after the presentation of a different problem; (2) correct answers and the CORRECT flag remain displayed for 0.4 second (unless modified as explained below); (3) an incorrectly answered problem and the NOT and right-side CORRECT flags remain displayed for 0.6 second (unless modified as explained below); and (4) when the user fails to answer a problem within the per-problem time limit, the problem and the NOT and right-side CORRECT flags remain displayed for 0.8 second (unless modified as explained below). The amount of time remaining for the answering of a problem when it was correctly or incorrectly answered (0 or 0.0 where the problem was not answered in time) is displayed at this time.

In the Flashcards learning activity, as in the Test learning activity, by designating the same problem format, the same number of problems to be answered (50 being the default number), the same time limit, the same arithmetic operation, and the same difficulty level and pushing the same number key prior to starting the activity, two or more users can perform the exact same Flashcards activity (i.e., the same problems in the same order subject to the same per-problem time limit). (It is also assumed that in each case the learning aid is set for the same Relative Length of Prompts. See discussion below.) This feature works just as in the Test learning activity, except that, of course, the roles of the TEST and FLASHCARDS keys are switched.

One refinement of the timing of this activity is the addition to the normally-applicable per-problem time limit of 0.2 second in the case of two-digit answers and of 0.3 second in the case of three-digit answers. For instance, assuming that the applicable time limit is 2 seconds, whereas a problem having a one-digit answer, in fact, has a time limit of 2.0 seconds, a problem having a two-digit answer actually has a time limit of 2.2 seconds, and a problem having a three digit answer (e.g., 12×12) actually has a time limit of 2.3 seconds. If the 1+?=3 problem format is in effect and the problem is 12×?=144, then the time limit is 2.2 seconds, since 12 is a two-digit answer. Finally, the 0.2- and 0.3-second additional time increments are not adjustable—unlike, as explained below, the lengths of time that prompts are displayed.

How Number of Problems Presented in Flashcards Activity can be Changed

When the learning aid is turned from OFF to ON, the number of problems to be presented in the Flashcards activity is always 50. Pushing PAUSE key 25 while FLASHCARDS key 15 is held down causes a ding sound effect and decreases the number of problems by 10 on the first push (unless the number is already at 10) until the number 10 is reached, at which point an additional push changes the number to 80, etc. The first digit of the two-digit number displayed to the left of the FLASHCARDS flag changes accordingly. The new number remains in effect until it is changed by means of the PAUSE and FLASHCARDS keys or until the learning aid is turned OFF. The number is not displayed when results are being displayed. It is displayed only when the learning aid is poised for the Flashcards activity or when that activity is in progress.

Provision to Improve Accuracy of the Count of Incorrect Answers

It is preferred that in the “Test” and “Flashcard” activities there be some provision to improve the accuracy of the count of incorrect answers. Consider the following situation: a child enters “4” and “5” in succession in answer to the problem “8×4=?”. Although the child has entered two numerals, it is clear that only one answer is intended. The microprocessor, however, needs some rule by which to distinguish this situation from the situation where “4” was entered in response to the first problem, and “5” was entered in response to a second, subsequent problem. To address this issue, it is preferred that the microprocessor, as soon as an incorrect numeral is entered (which in this case would be the entry of “4”) stop accepting numerals at that point. The microprocessor causes the display of the incorrect digit only briefly (for example, for only 0.3 seconds after the incorrect numeral is entered). It thereupon causes the display of a subsequent problem, and waits for a predetermined time after display of the subsequent problem (for example, 0.3 seconds) before it will accept entry of any additional digits. This procedure provides a temporal spacing that substantially eliminates the problem.

Special Problems Learning Activity

The learning aid has a missed-or-entered-problems memory. In one of two ways, problems can be stored in this memory. First, using ENTER PROBLEMS key 28 (discussed below) a user can “enter” in the 1+2=? problem format up to 15 different problems taught by the learning aid into this memory. Second, unless one or more problems have been entered into the missed-or-entered-problems memory by the ENTER PROBLEMS key and not subsequently erased by ERASE MISSED OR ENTERED PROBLEMS key 27, the learning aid automatically stores in that memory 15 different problems in the 1+2=? problem format that correspond to the problems most recently missed by a user, i.e., the problems most recently recorded as ATTEMPTED but not as CORRECT for purposes of the results-keeping function. For instance, if a user misses 6×?=42, 6×7=? is stored, but at no time does 6×7=? constitute more than one of the up to 15 problems stored in the missed-or-entered-problems memory.

If 15 different missed problems are accordingly being stored in the missed-or-entered-problems memory, then until that memory is totally erased (either by ERASE MISSED OR ENTERED PROBLEMS key 27 (discussed below) or by the complete entering of one problem into that memory by ENTER PROBLEMS key 28 (discussed below)), the making of an additional mistake has the effect illustrated by the following examples which assume that the memory initially contains the following 15 problems, ordered from least recently missed to most recently missed: 8×7, 6−2, 1+8, 9×6, 81 9, 4+3, 12−7, 15÷3, 10×0, 3×6, 14−8, 5+9, 1+1, 5×3, and 42÷7. If the user then misses 9×?=54 (a problem corresponding to a problem in the 1+2=? problem format that is already contained in the missed-or-entered-problems memory, i.e., 9×6), only the ordering of the problems in the memory is changed, namely to: 8×7, 6−2, 1+8, 81÷9, 4+3, 12−7, 15÷3, 10×0, 3×6, 14−8, 5+9, 1+1, 5−3, 42÷7, and 9×6. This change in ordering results even if there are fewer than 15 missed problems in memory. On the other hand, if the user instead misses ?×12=144 (a problem that does not correspond to a problem in the 1+2=? problem format that is already contained in the memory), then 8×7 is eliminated from the memory, and 12×12 is included in it as the 1+2=? counterpart of the most recently missed problem (resulting in: 6−2, 1+8, 9×6, 81÷9, 4+3, 12−7, 15÷3, 10×0, 3×6, 14−8, 5+9, 1+1, 5−3, 42÷7, and 12×12).

The user operates the Special Problems learning activity by following Step #1 through Step #6 described above under “Overview of Operation of Learning Activities”. However, since a Special Problems learning activity is not necessarily limited to a single arithmetic operation and does not entail a difficulty level or a table, Steps #3 and #4 are skipped. The starting of the activity by the pressing of the START key (Step #5) results in the user being presented-until the specified time limit expires—problems chosen almost randomly from the problems currently stored in the missed-or-entered-problems memory. Correct and incorrect answers are treated the same as in the Practice activity except for how long right-side CORRECT flag 63 and NOT and right-side CORRECT flags 61 and 63 are displayed. Results are displayed similarly, as well, except that no arithmetic operation symbol or difficulty level is displayed, and SPECIAL PROBS flag 41 and a MISSED flag 47 or an ENTERED flag 48 are displayed instead of PRACTICE flag 33. When the learning aid is poised for this activity, it does not display: an arithmetic operation symbol, a difficulty level, or a table number, but it does display: a blinking (0.6 second ON, 0.4 second OFF) NO flag 53 and a (constantly displayed) PROBLEMS IN MEMORY flag 54 if no problem is then stored in the missed-or-entered-problems memory; MISSED flag 47 and PROBLEMS IN MEMORY flag 54 with the appropriate one or two-digit number displayed to the left of MISSED flag 47 when one or more missed problems are stored in memory; and ENTERED flag 48 and PROBLEMS IN MEMORY flag 54 with the appropriate one or two-digit number displayed to the left of the undisplayed MISSED flag when one or more entered problems are stored in memory. (FIG. 2) One exception to the foregoing sentence is that if the learning aid is poised for the Special Problems activity by the pushing of ENTER PROBLEMS key 28 (discussed below) when no missed or entered problem is stored in memory, NO flag 53 does not blink but rather is displayed constantly. When this activity is in progress or paused or when results of this activity are being displayed, the display does not show: a difficulty level or a table number, or the NO or PROBLEMS IN MEMORY flags, or the number of problems in memory to the left of the MISSED flag, but it does show the arithmetic operation symbol of the problem currently being presented and the MISSED or ENTERED flag, as appropriate.

In the Special Problems activity, after the entry of a correct answer: the problem, the answer and right-side CORRECT flag 63 remain displayed for 0.7 second (unless modified as explained below). After the entry of an incorrect answer: the problem, the incorrect answer, NOT flag 61, and right-side CORRECT flag 63 remain displayed for 1.1 seconds (unless modified as explained below). When the NOT and right-side CORRECT flags have been displayed for those 1.1 seconds after a problem has been answered incorrectly at least twice in a row, the NOT flag is extinguished and the correct answer and the right-side CORRECT flag are displayed for 2.2 seconds (unless modified as explained below).

In the Special Problems activity, problems are always presented in the problem format currently designated. Thus, even if the user actually missed the problem 7×?=56, if the currently applicable problem format is ?+2=3, the learning aid presents the problem ?×8=56.

The Special Problems activity can be paused and unpaused just like the Practice learning activity.

Turning the learning aid OFF does not erase its missed-or-entered-problems memory, but pushing ERASE MISSED OR ENTERED PROBLEMS key 27 (discussed below) does. And, as indicated above, the complete entering of a single problem into that memory by the use of ENTER PROBLEMS key 28 (discussed below) erases any missed problems currently stored in it.

When (1) either (a) the learning aid is poised for the Special Problems learning activity, or (b) the learning aid is displaying results and Special Problems is the last-selected activity, and (2) the missed-or-entered-problems memory is empty, then pushing START key 22 results in: (1) the display of SPECIAL PROBS flag 41 and the applicable per-activity time limit; (2) the emission of the negative tones; and (3) the blinking of NO flag 53 and the constant illumination of PROBLEMS IN MEMORY flag 54.

If NO flag 53 is blinking, the pushing of ENTER PROBLEMS key 28 (among other things that are discussed below) constantly illuminates the NO flag since the pushing of this key presumably indicates an intention to enter a problem into memory, not the intention to immediately start the Special Problems activity. Thus, the NO flag is displayed constantly merely to inform the user of the amount of problems currently in memory, whereas the blinking of the NO flag is intended to indicate a problem to a user who plans to start the Special Problems activity immediately.

NO flag 53 blinks if, when the missed-or-entered-problems memory is empty, the learning aid is poised for the Special Problems activity by the pushing of TIME LIMIT key 19—either while the Special Problems activity is in progress or while results of a Special Problems activity are being displayed.

Erase-Missed-or-Entered-Problems Function

When and only when the learning aid is on, pushing ERASE MISSED OR ENTERED PROBLEMS key 27. (1) produces a ding sound; (2) clears any and all problems stored in the missed-or-entered-problems memory; and (3) poises the learning aid for the last-selected learning activity with the last-selected time limit (when applicable), the last-selected arithmetic operation (when applicable), and the last-selected difficulty level (when applicable) or the last-selected table number (when applicable). If this key is pushed while a learning activity is in progress, the results of the interrupted learning activity are not recorded.

Enter-Problems Function

This function allows a user to enter into the missed-or-entered-problems memory in the 1+2=? problem format from one to 15 different problems taught by the learning aid. Accordingly, problems entered by means of this function-until they are erased—can be practiced in the 1+2=? format or in either of the other two formats by the use of the Special Problems learning activity.

As in the case of missed problems: (1) problems are stored only in the 1+2=? problem format; (2) an entered problem is not included more than once in the missed-or-entered-problems memory; (3) if that memory contains 15 entered problems and the user enters another different problem, that different problem is added to the memory as the most recently-entered problem, and the least recently-entered problem in the memory is eliminated; and (4) if the memory contains between two and 15 entered problems and the user enters a problem that is already in the memory, the ranking of that problem is changed to that of the most recently entered, just as in the analogous example involving the missed problem 9×?=54 under “Special Problems Learning Activity” above.

As discussed below ENTER PROBLEMS key 28 is central to the enter-problems function. In addition, it also poises the learning aid for the Special Problems learning activity even though it does not have the exact same effect on the display as does poising the learning aid for this activity by means of a different key, including but not limited to SPECIAL PROBLEMS key 18. The display differences are explained in the following paragraph.

Following is an explanation of how the enter-problems function operates. First, while the learning aid is ON, the user pushes ENTER PROBLEMS key 28. As a result, the display appears just as if SPECIAL PROBLEMS key 18 had been pushed except: (1) that the horizontal line (made up of three adjacent LCD segments) below S1, S2 and S3 (the left-operand line) is blinking; (2) a composite of the symbols for the 4 arithmetic operations (the composite operator) is constantly displayed, instead of all of them being extinguished; (3) if the current problem format is not already 1+2=?, it changes to that format; and (4) if there are no problems currently stored in memory, NO flag 53 does not blink but rather is constantly displayed.

At this point the user pushes a number key corresponding to the leftmost digit of the left operand of the desired problem. The digit, like all digits displayed during this procedure, is constantly displayed as soon as it is typed.

If this first digit is 0, the left-operand line becomes constantly displayed and the last-selected arithmetic operator and the horizontal line (made up of three adjacent LCD segments) below S4, S5 and S6 (right-operand line) begin to blink, indicating that the user may either: (a) change the operator by pushing the +−×÷ key one or more times or (b) enter the first digit of the desired problem's right operand. Otherwise, the appearance of the display does not change.

If the first digit is not 0, typing it results in the continued blinking of the left-operand line and also in the blinking of the composite operator. Otherwise, the appearance of the display does not change. The blinking line and the blinking composite operator signal that the user can either enter another appropriate digit to the left operand or proceed to specify the appropriate operator. Then, if:

(A) the user pushes the +−×÷ key: (1) the left-operand line becomes constantly displayed since the user cannot at this point enter an additional digit for the left operand; and (2) an appropriate operator symbol (See discussion below as to which particular symbol.) and the right-operand line both begin to blink indicating that the user can either change the symbol by pushing the +−×÷ key one or more additional times or enter the leftmost digit of the right operand.

or, instead:

(B) the user enters a second appropriate digit to the left operand:

(1) if the left operand consequently becomes greater than 18: (a) the left-operand line becomes displayed constantly; (b) the division symbol becomes constantly displayed since no other operation would be appropriate; and (c) the right-operand line begins to blink;

(2) if the left operand consequently becomes 17: (a) the left-operand line becomes constantly displayed; (b) the subtraction symbol becomes constantly displayed since no other operation would be appropriate; and (c) the right-operand line begins to blink;

(3) if the left operand consequently becomes 15, 16, or 18: (a) the left-operand line becomes constantly displayed; and (b) an appropriate operation symbol (See discussion below as to which particular operation symbols are appropriate.) and the right-operand line both begin to blink indicating that the user can either push the +−×÷ key again to change the operation symbol or enter the leftmost digit of the right operand; and

(4) in all other cases, i.e., if the left operand is 10, 11, 12, 13, or 14: (a) the left-operand line continues to blink indicating that it is possible to enter an appropriate third digit; and (b) the composite operator continues to blink indicating that, alternatively, the user can specify an arithmetic operator. Then if the user types a third appropriate digit: (a) the left-operand line and the division symbol both become constantly displayed since division is the only appropriate operation; and (b) the right-operand line begins to blink. If, on the other hand, the user pushes the +−×÷ key instead of a third digit: (a) the left-operand line becomes constantly displayed indicating that another digit cannot be added to the left operand; (b) the right-operand line begins to blink indicating that the user can enter the leftmost digit of the right operand; and (c) if the left operand is 13, the minus symbol becomes constantly displayed since no other operation would be appropriate, but if the left operand is 10, 11, 12, or 14, an appropriate operation symbol begins to blink along with the right-operand line indicating that the user can either push the +−×÷ key again to change the operation symbol or enter the leftmost digit of the night operand.

When the user enters the first digit of the right operand, the operation symbol stops blinking and become constantly displayed if it has not already done so, and:

(A) if the arithmetic operation is subtraction or addition, the right-operand line becomes constantly displayed since no appropriate second digit exists,

(B) if the arithmetic operation is multiplication or division and the digit is not 1, the right-operand line becomes constantly displayed since no appropriate second digit exists,

(C) if the arithmetic operation is multiplication and the digit is 1, the right-operand line continues to blink since an appropriate second digit exists,

(D) if the arithmetic operation is division and the digit is 1 and the left operand is less than 10, the right-operand becomes constantly displayed since an appropriate second digit does not exist; and

(E) if the arithmetic operation is division, the digit is 1, and the left operand is greater than 9, the right-operand line continues to blink since an appropriate second digit exists.

If and when the user enters a second appropriate digit for the right operand, the right-operand line becomes constantly displayed since an appropriate third digit does not exist.

When the user has finished typing an appropriate right operand, the user pushes ENTER PROBLEMS key 28. Doing so: (1) enters the designated problem into the missed-or-entered-problems memory or, if the problem is already in that memory, makes it the most-recently entered problem therein; (2) causes a ding sound; (3) in the case of the first problem to be entered by means of the ENTER PROBLEMS key into the missed-or-entered-problems memory, erases any missed problems contained therein; (4) causes the correct answer to the problem to be displayed along with the problem for 0.5 second (Unlike the time intervals for most other prompts (See discussion below.), this time interval is not modifiable.); and (5) then causes the display to appear just as it appeared upon the initial pushing of the ENTER PROBLEMS key at the beginning of the entry procedure, except that the display correctly reflects the number of problems currently in memory. Thus, for example, if 7 missed problems have until then been in memory, the 7 changes to 1, MISSED flag 47 is extinguished, ENTERED flag 48 becomes displayed, and PROBLEMS IN MEMORY flag 54 remains displayed. At this point, even in the case of the 15^{th} entered problem, the user can enter another problem or opt to do something else—for instance: start the Special Problems learning activity by pushing START key 22; poise the learning aid for any learning activity by pushing the activity's key; erase all entered problems by pushing ERASE MISSED OR ENTERED PROBLEMS key 27; etc.

When, because of the user's pushing of a number key or +−×÷ key 20, the composite operator changes to a blinking arithmetic symbol, the blinking symbol corresponds to the last-selected arithmetic operation unless there is not a problem taught by the learning aid with that arithmetic operation and the just-entered first operand, in which case the “next appropriate” arithmetic symbol is displayed. For instance, if the user types 10 as the first operand and addition is the last-selected arithmetic operation, then the addition symbol is not displayed because none of the addition problems taught by the learning aid has 10 as its first operand. Consequently, a blinking subtraction symbol—the next appropriate symbol after the addition symbol—is displayed. And if the user pushes the +−×÷ key three more times, a blinking multiplication symbol, then a blinking division symbol, and finally a blinking subtraction symbol are displayed. Similarly if the user types 14 as the first operand and subtraction is the last-selected arithmetic operation, then, when the user first pushes the +−×÷ key, a blinking subtraction symbol is displayed, and if the user pushes the +−×÷ key two more times, on the first push, the multiplication symbol is skipped and a blinking division symbol is displayed, and, on the second push, the addition symbol is skipped and a blinking subtraction symbol is displayed, As one last example: if the user types 15 as the first operand and division is the last-selected arithmetic operation, then as soon as the 5 in 15 is typed, the division symbol immediately begins to blink since the learning aid does not teach a problem having a three-digit left operand beginning with 15, and if the user pushes the +−×÷ key twice, the minus symbol starts blinking after the first push and the division symbol again after the second.

If the +−×÷ key is pushed either when the composite operator or a particular operational symbol is being constantly displayed, the learning aid simply emits the negative tones because the +−×÷ key is inert. Only problems that are in the 1+2=? problem format and taught by the learning aid can be entered into its missed-or-entered-problems memory. If a number key is pushed when neither the left-operand line nor the right-operand line is blinking, the number key is inert, and, therefore, only the negative tones result. If an inappropriate number key is pushed while an operand line is blinking: (1) the negative tones are emitted; (2) the inappropriate digit is displayed for 0.3 second (Unlike the time intervals for most other prompts (See discussion below.), this time interval is not modifiable.); and (3) immediately thereafter the display appears exactly as it appeared upon the previous pushing of the ENTER PROBLEMS key.

When the left-operand line is blinking and no digit is displayed above it, pushing the ENTER PROBLEMS key results solely in the emission of the negative tones because under these circumstances this key is inert. When a complete problem taught by the learning aid is not displayed but one or more digits of such a problem are displayed, pushing the ENTER PROBLEMS key results in: (1) the emission of the negative tones; and (2) the display's appearing exactly as it appeared upon the previous pushing of the ENTER PROBLEMS key. This could happen if this key is pushed: (1) when part but not all of the left operand has been entered; (2) when all of the left operand has been entered but the arithmetic operator has not been selected; (3) when all of the left operand has been entered and an arithmetic operator has been selected but no digit has been entered for the right operand; or (4) when the user has designated the first operand, division as the arithmetic operation, and 1 as the first digit of the right operand and the problem displayed, e.g., 99÷1, is not taught by the learning aid.

If the user is in the process of entering a problem but has not finished doing so, pushing any of the following keys clears the partly-entered problem and implements what normally results from the pushing of that key: any of the six learning activity keys; PROBLEM FORMAT key 31; ERASE RESULTS key 30 (discussed below); HIDE OR SHOW COUNTDOWN key 26 (discussed below); ERASE MISSED OR ENTERED PROBLEMS key 27; ON/OFF key 24; SEE RESULTS key 29; START key 22, which starts the Special Problems activity unless no missed or entered problems are in the missed-or-entered-problems memory, in which case the negative tones result, NO flag 53 begins to blink, and PROBLEMS IN MEMORY flag 54 remains displayed constantly along with SPECIAL PROBS flag 41 and the selected time limit, etc.; and TIME LIMIT key 19, which changes the applicable per-activity time limit and makes the display appear as if SPECIAL PROBLEMS key 18 has been pushed.

If the user is in the process of entering a problem but has not finished doing so, repositioning switch 23 changes the sound level to the selected setting but has no other effect. If the user is in the process of entering a problem but has not finished doing so, pushing PAUSE key 25 or LEVEL # OR TABLE # key 21 results solely in the negative tones since these keys are then inert.

Digit and ? Placement in Enter-Problems Function

When the enter-problems function is being used, the display appears as follows:

In the left-operand spaces (S1, S2, & S3), the first digit entered appears in S2. If a second digit is entered, that second digit appears in S2 and the first digit moves to S1. If a third digit is entered, that third digit appears in S3 and the other digits do not move.

2. In the right-operand space (S4, S5, & S6), the first digit entered appears in S5. If a second digit is entered, that second digit appears in S5, and the first digit moves to S4.

3. A ? is always displayed in S9, except when ENTER PROBLEMS key 28 is pushed after the entering of an appropriate night operand, in which event the answer to the problem being entered is displayed in S9 if the answer consists of one digit, in S8 and S9 if the answer consists of two digits, and in S7, S8, and S9 if the answer consists of three digits.

Hide-or-Show-Countdown Function

When the learning aid is turned from OFF to ON, it is in countdown-shown mode. That is, when a learning activity that involves a time limit is in progress, the gradual expiration of the applicable time limit is displayed.

When and only when the teaming aid is ON, pushing HIDE OR SHOW COUNTDOWN key 26. (1) changes the learning aid from countdown-shown mode to countdown-hidden mode or vice versa; (2) unless sound has been switched to OFF, causes a ding sound; (3) illuminates or extinguishes a HID flag 42; and (4) poises the device for the last-selected learning activity. If this key is pushed while a learning activity is in progress, the results of the interrupted learning activity are not recorded.

Two of the teaming aid's six learning activities are not subject to time limits, namely, the Table-In-Order and the Table-No-Order learning activities. Consequently, when the learning aid is poised for one of these two learning activities or when one of them is in progress, the hide-or-show-countdown function is, for the moment, irrelevant. Nevertheless, even when either of the Table activities is selected, HIDE OR SHOW COUNTDOWN key 26 is still functional, and if the learning aid is in countdown-hidden mode, HID flag 42 is displayed.

The Practice, Test, Flashcards, and Special Problems learning activities are, however, always subject to time limits—whether countdown-shown mode or countdown-hidden mode is in effect. When the learning aid is poised for any of these four timed learning activities, the applicable time limit is displayed in the upper left corner of display 11—again, whether countdown-shown mode or countdown-hidden mode is in effect. When one of these four timed learning activities is in progress and countdown-shown mode is in effect, the display shows the countdown of the applicable time limit to zero. On the other hand, when one of these four timed learning activities is in progress and countdown-hidden mode is in effect, the display does not show the countdown of the applicable limit to zero. Instead, the original time limit is frozen on the display. It does not even change—for instance, to 0—when the time limit expires.

The purpose of the countdown-hidden mode is to eliminate the visual distraction of the countdown of the time limit in the case of users who would be significantly bothered by it. Whenever this mode is in effect, the HID flag is displayed.

Additional Explanation of See-Results Function

The learning aid records the results of the last nine learning activities performed on it—with two exceptions: (1) learning activities terminated while in progress by the pushing of a key other than SEE RESULTS key 29; and (2) Practice or Special Problems learning activities terminated by the pushing of a key other than the SEE RESULTS key when those activities are paused. Results are displayed one at a time—in the order of the most recent result first—in response to each push of the SEE RESULTS key. After the least recently recorded result has been displayed, pressing this key displays again the results of the most recently performed learning activity. If the SEE RESULTS key is pushed while a learning activity is in progress or while the Practice or Special Problems learning activity is paused, the learning activity is terminated and the result of the interrupted activity are both displayed—without sound effects—and recorded as the most recent result. By contrast, if a learning activity that is in progress is interrupted by any key other than SEE RESULTS key 29 or PAUSE key 25, the results of the interrupted learning activity are discarded. It should be understood that in any event, only the last nine learning activities are stored by the learning aid in memory. As a new result comes in, the oldest result is discarded so that at all times only the most recent nine results are stored.

Following is an example which illustrates how results are displayed when SEE RESULTS key 29 is used. Assuming that a result is not currently being displayed, that a learning activity is not currently “in progress” or “paused”, and that a total of only eight results are currently recorded in memory, pushing SEE RESULTS key 29 two times results in the following being displayed after the second pushing of the key:
RESULT flag 46;
to its right, a “7” since this is the second-most recent record, the most recent being 8;
the flag(s) of the learning activity in question;
if the activity is Special Problems, MISSED flag 47 or ENTERED flag 48, as appropriate;
the symbol of the arithmetic operation in question, except in the event that Special Problems is the learning activity being reported on;
the number of problems answered correctly—as well as on time, in the case of the Flashcards activity—in S1, S2 and S3;
a continuous horizontal line made up of three adjacent LCD segments below S1, S2 and S3;
left-side CORRECT flag 57;
the number of problems attempted in S4, S5, and S6 (If a user responds to a problem first with an incorrect answer, then with another incorrect answer, and finally with the correct answer, three problems have been attempted. If in the Flashcards activity, a user fails to answer a problem correctly before the per-problem time limit expires, that problem is considered to have been attempted. But a problem is not considered to have been attempted where the expiration of a per-activity time limit prevents it from being answered correctly or incorrectly.);
a continuous horizontal line made up of three adjacent LCD segments below S4, S5 and S6;
ATTEMPTED flag 59;
the percentage, rounded to the nearest percent, of the problems attempted answered correctly in S7, S8 and S9 unless the number of attempted problems is zero;
a continuous horizontal line made up of three adjacent LCD segments below S7, S8 and S9;
large % flag 64;
blinking WOW!! flag 56 if the percentage is 100% and at least 20 problems were attempted;
small % flag 62;
right-side CORRECT flag 63;
in the case of the Practice, Test, or Special Problems learning activity, the total amount of seconds that elapsed during the activity, which equals the time limit chosen for the activity unless the user terminates the activity before the expiration of the time limit by pressing the SEE RESULTS key;
in the case of the Flashcards learning activity, the per-problem time limit that applied to the Flashcards activity being reported on;
in the case of the Practice, Test, Special Problems, or Flashcards learning activity, SECONDS flag 51;
LEVEL flag 49 in the event of the Practice, the Test or the Flashcards learning activity;
to the right of the location of LEVEL flag 49 (whether or not it is displayed), a number between 1 and 9 in the event of the Practice, the Test, or the Flashcards learning activity, a number between 0 and 12 in the event of a Table learning activity, and no such number in the case of the Special Problems learning activity since it uses neither a level or a table;
in the event of a Table learning activity, —TABLE flag 50; and
in the event of the Test or Flashcards learning activity if a specific sequence of problems was specified, the single-digit sequence number immediately to the right of TABLE: flag 36.

When the results of an activity are displayed, display 11 indicates whether sound is currently OFF, LOW, or HIGH by displaying flag 43, flag 44, or both flag 44 and flag 45, respectively, and whether or not the learning aid is currently in countdown-hidden mode by displaying HID flag 42 or not. Thus, in these two respects, the present status of the learning aid is displayed, not its status when the results were generated.

Results are stored by the learning aid even when it is turned OFF. If no results are being stored and the SEE RESULTS key is pushed, the learning aid displays a 0 to the right of RESULT flag 46 in addition to what is indicated by the preceding example. If the SEE RESULTS key is pressed while a Practice or Special Problems activity is paused, the results of the now-terminated—no longer just paused—Practice or Special Problems activity are displayed, and PAUSED flag 52 is extinguished.

Digit and ? Placement when Results are being Displayed

When results are being displayed:

1. With respect to the number of correct answers, a single-digit number is displayed in S1; a two-digit number in S1 and S2; and a three-digit number in S1, S2 and S3.

2. With respect to the number of problems attempted, a single-digit number is displayed in S6; a two-digit number in S5 and S6; and a three-digit number in S4, S5 and S6.

With respect to the number of percent answered correctly: a single-digit number is displayed in S9; a two-digit number in S8 and S9; and a three-digit number (i.e., 100) in S7, S8 and S9.

Erase-Results Function

When and only when the learning aid is ON, pushing ERASE RESULTS key 30 does the following: (1) it generates a ding sound (unless sound is switched to OFF); (2) it eliminates all results from its memory; and (3) it poises the learning aid for the last-selected learning activity with the last-selected time limit when applicable, the last-selected arithmetic operation when applicable, and the last-selected difficulty level when applicable or the last-selected table number when applicable. If this key is pushed while a learning activity is in progress, the results of the interrupted learning activity are not recorded.

Note about Extinguishing of TRY AGAIN flag

TRY AGAIN flag 55 is extinguished by the pushing of any non-inert key (including any number key, correct or incorrect) but not by the use of SOUND switch 23.

Supplemental Information about Certain Keys—the TIME LIMIT Key.

TIME LIMIT key 19 is inert when and only when no number is displayed to the left of SECONDS flag 51.

When the learning aid is poised for either the Practice, the Test, or the

Special Problems learning activity, pushing TIME LIMIT key 19 changes the currently displayed per-activity time-limit to the next shorter one—unless no shorter time limit exists, in which case the longest is selected and displayed. When the result of one of these three activities is being displayed, pushing the TIME LIMIT key has the same effect and also poises the learning aid for the activity whose result was being displayed, not for the last-selected activity. In the case of the Practice and Test activities, the arithmetic operation and level that were displayed as part of the activity's result are retained, not the last-selected operation and level.

When the learning aid is poised for the Flashcards learning activity, pushing the TIME LIMIT key changes the currently displayed per-problem time-limit to the next shorter one—unless no shorter time limit exists, in which case the longest is selected and displayed. When the result of a Flashcards activity is being displayed, pushing the TIME LIMIT key has the same effect and also poises the learning aid for that activity in the same arithmetic operation and level as displayed as part of the activity's results, not the last-selected operation and level.

When the user is in the process of entering a problem into the missed-and-entered-problems memory, pushing the TIME LIMIT key selects the next applicable per-activity time limit, clears the display of any partially entered problem, and poises the learning aid for the Special Problems learning activity as if SPECIAL PROBLEMS key 18 had been pushed.

When a learning activity having a time limit is in progress or the Practice or Special Problems activity is paused, pushing the TIME LIMIT key poises the learning aid embodiment for the activity in question with the last-selected time limit—not the next lower time limit.

Supplemental Information about Certain Keys—the +−×÷Key

When the learning aid is poised for a Table-In-Order, Table-No-Order, Practice, Test, or Flashcards activity, pushing +−×÷ key 20 changes the currently-displayed arithmetic operator to the “next” one in keeping with the following order: +, −, ×, ÷, etc. When the result of one of these five activities is being displayed, pushing the +−×÷ key has the same effect and also poises the learning aid for the particular activity whose result was being displayed and in the level or table number that was being displayed, except that, as explained previously, sometimes the table number is necessarily adjusted. If a time limit applies to the activity in question, the resulting time limit is the shortest of the possible time limits that equal or exceed the number of seconds that was being displayed immediately prior to the pushing of the key.

When one of these five activities is in progress or when the Practice activity is paused, pushing the +−×÷ key changes the currently-displayed arithmetic operator to the one that follows it and poises the learning aid for the activity in question with the last-selected time limit, if any applies to the activity in question, and with the last-selected table or level number, as appropriate to the activity in question.

The +−×÷ key is inert: (1) when no +, −, ×, ÷, or composite operator is constantly displayed or blinking; (2) when a problem is in the process of being entered and no such symbol or composite operator is blinking; (3) when the Special Problems learning activity is in progress or paused; and (4) when the learning aid is OFF.

Supplemental Information about Certain Keys—the LEVEL # OR TABLE # Key

When the learning aid is poised for a Practice, Test, or Flashcards activity, pushing LEVEL # OR TABLE # key 21 sequentially changes the level of difficulty by one level to the “next” level—in ascending order until 9 is reached at which point the next level is 1. When the result of one of these three activities is being displayed, pushing the LEVEL # OR TABLE # key has the same effect and also poises the learning aid for the particular activity whose result was being displayed and in the currently-displayed arithmetic operation and with the lowest time limit that equals or exceeds the number until then displayed to the left of SECONDS flag 51. When one of these three activities is in progress or the Practice activity is paused, pushing the LEVEL # OR TABLE # key changes the level to the “next” level and poises the learning aid for the currently-displayed learning activity and with the last-selected time limit and currently-displayed arithmetic operation.

If the learning aid is poised for either of the two Table activities, pushing LEVEL # OR TABLE # key 21 sequentially selects—in ascending order—the appropriate addition table, i.e., 0 to 9, if the × symbol is being displayed, the appropriate subtraction table, i.e., 0 to 9, if the − symbol is being displayed, the appropriate multiplication table, i.e., 0 to 12, if the × symbol is being displayed, or the appropriate division table, i.e., 1 to 12, if the ÷ symbol is being displayed. When the result of one of these two activities is being displayed, pushing the LEVEL # OR TABLE # key changes the table number to the next appropriate number and also poises the learning aid for the particular activity whose result was being displayed. The arithmetic operation that was displayed as part of the activity's result is retained. When one of these two Table activities is in progress, pushing the LEVEL # OR TABLE # key changes the table to the next appropriate table and poises the learning aid for the currently-displayed Table activity with the currently-displayed arithmetic operation.

The LEVEL # OR TABLE # key is inert: (1) when the SPECIAL PROBS flag is displayed; (2) when RESULT 0 (reflecting the absence of any recorded results) is displayed; and (3) when the learning aid is OFF. As explained above, sometimes pushing the +−×÷ key can change the table or level number, and sometimes pushing the TABLE-IN-ORDER or the TABLE-NO-ORDER key can change the table number. When turned from OFF to ON, the learning aid remembers and reverts to the last-selected table number, whether the selection was made by pushing the LEVEL # OR TABLE 4 key, the +−×÷ key, the TABLE-IN-ORDER key, or the TABLE-NO-ORDER key.

Supplemental Information about Certain Keys—the START Key

If the learning aid is ON, with two exceptions, pushing START key 22 always starts the last-selected learning activity with the last-selected arithmetic operation when applicable, the last-selected difficulty level or the last-selected table number when applicable, the last-selected time limit when applicable, and, only if the learning aid is currently poised for the Test or Flashcards activity, any currently-selected sequence number. One exception is when the Practice or Special Problems learning activity has just been paused by PAUSE key 25, in which case pushing START key 22 simply “unpauses” the Practice or Special Problems activity. The second exception is when the learning aid is poised for the Special Problems learning activity and the missed-or-entered-problems memory is empty, in which case pushing the START key results in the negative tones and begins or continues the blinking of NO flag 53 while PROBLEMS IN MEMORY flag 54 remains displayed.

If the START key is pushed while a learning activity is in progress, that same learning activity is restarted from the beginning with the digital timer restored to the applicable time limit, but the results of the interrupted learning activity are not recorded. If the Test or Flashcards activity is in progress and a specific sequence of problems has been specified by the pushing of a number key prior to the initial starting of the activity, then the pushing of the START key clears the sequence number before restarting the activity.

Supplemental Information about Certain Keys—the Pause Key.

When the Practice or Special Problems learning activity is in progress, the user can stop the running of the digital timer by pushing PAUSE key 25—thereby pausing the Practice or Special Problems learning activity and causing PAUSED flag 52 to blink—and then restart the running of the timer and extinguish PAUSED flag 52 by pushing the same key again or START key 22. The PAUSE key, with two exceptions, is inert when each of the Practice and Special Problems learning activities is neither in progress nor paused. As explained above, one exception is when PAUSE key 25 is pushed while FLASHCARDS key 15 is held down to change the amount of problems to be answered in the Flashcards activity. As explained below, the second exception is when the PAUSE key is used to adjust the Relative Length of Prompts when the learning aid is turned OFF and HIDE OR SHOW COUNTDOWN key 26 and PROBLEM FORMAT key 31 are held down. If the PAUSE key is pushed when it is inert and the learning aid is ON, the negative tones result. Otherwise, pushing it results in no sound effect.

Supplemental Information about Certain Keys—the Four Small Recessed Keys

When the learning device is ON, pushing any of the four small recessed keys (defined above) always: (1) generates a ding sound unless sound is switched to OFF, and (2) poises the learning aid for the last-selected learning activity with the last-selected time limit when applicable, the last-selected arithmetic operation when applicable, and the last-selected difficulty level or the last-selected table number when applicable. If the learning aid is poised for either the Test or the Flashcards activity and a sequence number is displayed, the sequence number is not cleared by the pushing of any of the four small recessed keys. Under any other circumstances a displayed sequence number is cleared by the pushing of any of these four keys.

Automatic-Power-Down Feature

If the learning aid is ON but does not receive any key input, it will turn OFF automatically after four minutes unless it is paused in the middle of either the Practice or the Special Problems activity, in which case it will automatically turn OFF after 20 minutes of no key input.

Information Stored when Learning Aid is OFF

Even when OFF, the learning aid retains in memory: the last-selected learning activity; the last-selected per-activity and per-problem time limits; the last-selected arithmetic operation (+, −, ×, ÷); the last-selected table number; the 15 or fewer problems in the missed-or-entered-problems memory; whether those problems are missed or entered problems; the order in which any missed of entered problems were added to that memory; the results of up to the last nine uses, including the order of these results and including, in the case of a Special Problems activity, whether the problems were missed or entered; and the last-selected value for the Relative Length of Prompts (discussed below), since this information is needed when the learning aid is turned from OFF to ON.

If the batteries are removed and then replaced, when the learning aid is first turned ON, it sets itself for: the Practice learning activity; addition; the “5” table; a per-activity time limit of 90 seconds; a per-problem time limit of 4 seconds, and the normal value of 5 for the Relative Length of Prompts (discussed below).

There is no need for the learning aid to remember: a difficulty level; whether when the learning aid was last used, it was in countdown-hidden mode or not; which problem format it was in when it was last used; the number of problems to be presented in the Flashcards activity; which sound level was selected; or a sequence number; since when the learning aid is turned from OFF to ON, it defaults to: difficulty level 7, countdown-shown, problem format 1+2=?, 50 Flashcard problems, the sound level currently selected by switch 23, and no sequence number.

Determination and Adjustment of Relative Length of Prompts

When the learning aid is OFF, its 17 time delays (for the illumination of correctly answered problems, incorrectly answered problems, and correct answers for problems that have just been answered incorrectly) can be multiplied by 11/6, 9/6, 7/6, 5/6, 4/6, 3/6, 2/6 or restored to normal (6/6). Adjustments remain in effect until new ones are effected or until the batteries run down or are removed.

Simultaneously pressing HIDE OR SHOW COUNTDOWN key 26 and PROBLEM FORMAT key 31 while the learning aid is OFF illuminate: RELATIVE LENGTH OF PROMPTS flag 58 and NORM=5 flag 60 as well as a digit from 1 to 8 in S3 reflecting the current Relative Length of Prompts. No sound effect results. 5 is the normal default setting although the learning aid reverts back to this value automatically only when its batteries run down or are removed—not when it is merely turned OFF or ON. 8 is the highest setting and corresponds to the factor of 11/6.

Adjustments to the relative length of prompts can be effected only when the learning aid is OFF by pressing one or more times PAUSE key 25 while simultaneously holding down HIDE OR SHOW COUNTDOWN key 26 and PROBLEM FORMAT key 31. Doing this causes a ding unless sound is switched to OFF and illuminates: RELATIVE LENGTH OF PROMPTS flag 58 and NORM=5 flag 60 as well as a digit from 1 to 8 in S3 reflecting the new Relative Length of Prompts. Simultaneously pushing keys 25, 26 and 31 increases the current setting by one, unless that setting is 8, in which case the next setting is 1.

The following time parameters are not affected when the Relative Length of Prompts is changed: (1) the extra time allowed for the entry of two and three-digit answers in the Flashcards activity; (2) the amount of time an inappropriate digit is displayed after it is entered in the enter-problems function; (3) the three-second illumination period applicable to Relative Length of Prompts; (4) the amount of time the answer to a problem just entered into memory is displayed; and (5) the 0.3 second period during which answers are not accepted after the presentation of a new problem following an incorrect answer to the preceding problem in the Test and Flashcards activities.

The Terms “Almost Random” and “Almost Randomly”

The terms “almost random” and “almost randomly” should be construed to mean random or randomly with the following exceptions. When the random selection of a problem would result in the repetition of the problem just presented, the learning aid, if possible, does not present the problem selected and instead presents a different randomly selected problem. In the Table-No-Order and the Special Problems activity, the group from which problems are being randomly selected can conceivably include only one problem, in which case the repetition of a problem can be unavoidable. In addition, random number generators (either algorithms or circuitry) do not generate numbers that are truly random in the mathematical sense. The terms “random” and “randomly” in the present application are intended to refer to that degree of randomness resulting from use of commonly available random number algorithms used in connection with microprocessors and similar integrated circuits, and not to pure mathematical randomness.

Programming of Microprocessor to Function as the Question Engine

As previously stated, the question engine functions of the learning aid are implemented in an assembly program that controls the learning aid's above-described Sunplus SPL31A microprocessor. The various steps performed by the system are set forth above, and of course the particular code instructions to perform those steps will vary depending upon the particular processor used. Preparation of such a program is well within the skill of one of ordinary skill in the art of programming microprocessor devices, and so is not described in detail herein. No invention is claimed in the particular programming steps unique to the Sunplus SPL31A microprocessor.

The reader will see that I have provided a learning aid which satisfies not only the requisites of affordability and portability but also the requisites of “supervisability” and problem-selection efficiency.

The preferred embodiment satisfies the prerequisite of “supervisability” without compromising affordability or portability. Even when turned off, it retains evaluative information about up to nine problem sets, each of which is as many as 180 seconds or 80 problems long. The nine-problem-set maximum economically conserves memory and protects against inundating a teacher or parent with excessive information. But, to maximize the utility of the evaluative information retained, when the device is storing information about nine sets of problems and another set is completed, information about the least-recently completed set is deleted to make room for information about the just-completed one. Moreover, despite its display's limited size (dictated by the need for affordability and portability), the device communicates this information rapidly and very understandably by displaying it only one problem set at a time. In short, limited memory and limited display size are used in an efficient and novel manner to communicate ample and up-to-date evaluative information.

These performance-evaluation-communication features make it relatively easy and convenient for a parent or teacher to ensure that a child has used the learning aid as instructed—even when a substantial amount of work has been performed when the parent or teacher has not been physically or mentally present. The child is aware of the child's inability to fool a parent or teacher in this regard and of the ease with which the parent or teacher can check on the amount, nature and quality of the child's work. Consequently, provided that the consequences of not making a good faith effort are appropriate and clearly communicated, the child is much more likely to make such an effort

Without sacrificing affordability, portability, or “supervisability”, the preferred embodiment also satisfies the requisite of problem-selection efficiency.

First, it uses different levels not only to designate which problems are presented but also to determine the relative frequencies with which those particular problems are presented. Thus, for example, if a user selects a level including all multiplication problems with operands from 0 to 9, the probability of presentation for each of the 36 problems having 0 or 1 as one or both of their operands need not be the same as for 9×9, 9×3 or 3×9. In fact, in the case of the preferred embodiment, in level 6 for multiplication, everything else being equal, each of the just-referenced 36 problems has 0.14% probability of presentation, except for 0×0 and 1×1 which each have a probability of 0.28%, whereas 9×9, 9×3, and 3×9 have probabilities of 2.08%, 1.11%, and 1.11%, respectively. Or to take another example, level 5 for multiplication not only focuses almost exclusively on the difficult single-digit-operand problems but also presents the more difficult of those problems more often. Consequently, the probabilities of 0×3, 4×8, and 6×7, for instance, are 0.00%, 0.92%, and 4.62%, respectively.

In addition, the preferred embodiment's novel missed-questions features further contribute to problem-selection efficiency. The ability to practice missed problems collected from more than one previous set of problems makes the practicing of missed problems much more productive. And the continual updating of missed problems by, when necessary, eliminating old ones to make room for new ones not only tends to focus the user on the most relevant problems but also allows the device to get the most use out of limited memory capacity. Finally, the retention of these problems in memory even when the device is turned OFF allows the user to practice them during more than one session.

The just-described problem-selection features drastically reduce the amount of time that would otherwise be wasted answering problems that are too easy, too difficult or otherwise inappropriate for the user. Consequently, the user needs much less time—per daily session and overall—to master the targeted arithmetic skills. Since the task is less onerous both for the user to perform and thus also for a parent or teacher to supervise, it is much more likely to be accomplished satisfactorily.

Although the description above contains many specifics, these should not be construed as limiting the scope of the invention but as merely providing illustrations of some of the currently preferred embodiments of the invention

There are numerous variations or modifications that can be incorporated into other embodiments of the learning aid and that are known to and within the understanding of persons skilled in the art. Some examples of alternative embodiments are described below.

One embodiment enables the user to review the missed or entered problems stored in memory in chronological order or otherwise by, for instance, the simultaneous depression of two keys, such as PAUSE key 25 and SPECIAL PROBLEMS key 18.

Another embodiment has fewer than four arithmetic operations.

Another embodiment enables the user to answer a combination of addition, subtraction, multiplication, and/or division problems in the same single set of problems in accordance with the Practice mode, Test mode, Flashcards mode, or other mode—in addition to the Special Problems mode.

Another embodiment stores missed problems and entered problems separately and, therefore, does not require the user to choose between one or the other, in which case there can also be a way to erase only missed problems and a way to erase only entered problems. The initial depression of a key like SPECIAL PROBLEMS key 18 could activate the learning aid as to, for instance, missed problems, and the subsequent depression of the key could activate it as to entered problems. Or two separate keys, such as a MISSED PROBLEMS key and an ENTERED PROBLEMS key, could replace the SPECIAL PROBLEMS key.

Another group of embodiments treats missed and/or entered problems as separate sources of problems, just as the various levels are sources of problems. Thus, after designating a learning activity like the Practice, Test or Flashcards activity, instead of designating a level with a level key, the user can designate missed problems with, for example, a MISSED PROBLEMS key or entered problems with, for example, an ENTERED PROBLEMS key. This obviates the need for a Special Problems learning activity.

Another embodiment—by means of a microprocessor having synthesized speech capability—gives the user the option of hearing the announcement of problems and possibly also of answers and/or messages of evaluation, encouragement and/or guidance as to the proper use of the device.

Another embodiment, by means of a voice-recognition technology, allows the user to orally enter answers to problems presented and/or to orally control some or all aspects of the operation of the device—instead of doing so by key input.

Another embodiment is substantially more compact than the described preferred embodiment and therefore even more conveniently portable and easier to operate while held in the operator's hands so that it is easily usable without the help of a supporting surface, such as a table top or lap.

Another embodiment uses a single key to cycle through all possible learning activity modes, rather than one key for each mode.

Another embodiment can communicate, by infrared or other wireless means, to a mother computer accessible to a teacher currently-stored results information along with information identifying the particular device providing the results. This capability makes it convenient for a teacher to have students in a class download the results of their work onto a central computer, which, using appropriate software, keeps track of those results on a student-by-student basis and possibly uses the results to generate individual assignments for students and analyses and summaries of students' work. The students can download their results regularly—for instance, their homework upon their arrival in the relevant classroom and their work performed in school upon its completion or at the end of class. Similarly, sets of problems can be downloaded from the central computer (or the teacher's computer) into the electronic learning aid. This allows the teacher to customize problem sets for the class or the individual user of the learning aid.

Another group of embodiments uses an alternative to the above-described preferred embodiment's number keys which alternative makes use of two thumb-activated cross-shaped key pads, each similar to a type of key pad used in some digital cameras. The left key pad could interact with actuators indicating inputs for the numbers 1, 2, 3, and 4 when one of the four arms of the cross is depressed and the number 5 when the center of the cross is depressed. The right key pad could interact with actuators indicating inputs for the numbers 6, 7, 8, and 9 when one of the four arms of the cross is depressed and the number 0 when the center of the cross is depressed. In other arrangements, the ten different integers could be assigned among the ten locations on the two key pads differently than just described.

Another embodiment uses an alternative to the above-described embodiment's number keys which alternative uses only one cross-shaped key like the two just described in conjunction with a shift key. For instance, the cross-shaped key pad could operate like the left key pad in the example immediately above when the shift key is not depressed and like the right key pad in the example above when the shift key is depressed.

Another group of embodiments uses an alternative to the above-described embodiment's number keys which alternative uses only one cross-shaped key like those just described in conjunction with five separate thumb-activated keys also located on the top surface of the device. These five separate keys are operable by the thumb of one hand, and the cross-shaped key is operable by the thumb of the other hand.

Another embodiment uses an alternative to the above-described embodiment's number keys which alternative uses: two non-thumb-activated keys and two thumb-activated cross-shaped key pads, each similar to a type of key pad common in handheld games and handheld game controllers. The left non-thumb-activated key could interact with an actuator indicating input for the number 5, and the right non-thumb-activated key could interact with an actuator indicating input for the number 0. The left key pad could interact with actuators indicating inputs for the numbers 1-4 when one of the four arms of the cross is depressed, and the right key pad could interact with actuators indicating inputs for the numbers 6-9 when one of the four arms of the cross is depressed. In other arrangements, the ten different integers could be assigned among the ten locations on the two keys and two key pads differently than just described.

Another embodiment uses an alternative to the above-described embodiment's number keys which alternative uses a shift key in conjunction with one non-thumb-activated key and one cross-shaped key like those described in the immediately-preceding paragraph. For instance, one non-thumb-activated key and one cross-shaped key like those described in the immediately-preceding paragraph could operate like the left non-thumb-activated key and the left key pad in the immediately-preceding example when the shift key is not depressed and like the right non-thumb-activated key and the right key pad in the example above when the shift key is depressed.

Another group of embodiments uses an alternative to the above-described embodiment's number keys which alternative uses one cross-shaped key like the one specified in the immediately-preceding paragraph in conjunction with six separate thumb-activated keys. These six separate keys are operable by the thumb of one hand, and the cross-shaped key is operable by the thumb of the other hand.

Another embodiment uses an alternative to the above-described embodiment's number keys which alternative uses five separate left-thumb-activated keys and five separate right-thumb activated keys. The left-thumb keys could interact with actuators indicating inputs for the numbers 1, 2, 3, 4, and 5. The right-thumb keys could interact with actuators indicating inputs for the numbers 6, 7, 8, 9, and 0. In other arrangements, the ten different integers could be assigned among the ten keys differently than just described.

Another embodiment uses an alternative to the above-described embodiment's number keys which alternative uses a shift key in conjunction with either five separate left-thumb-activated keys or five separate right-thumb activated keys.

Another group of embodiments uses an alternative to the above-described embodiments number keys which alternative uses: one left-thumb-activated key and one right-thumb activated key on the top of the case and a key for each of the four non-thumb fingers of the left hand and a key for each of the four non-thumb fingers of the right hand on the underside of the case. The left-thumb key could interact with an actuator indicating input for the number 1 and the right-thumb key could interact with an actuator indicating input for the number 6. The left non-thumb keys could interact with actuators indicating inputs for the numbers 2, 3, 4, and 5 and the right non-thumb keys with actuators indicating inputs for the numbers 7, 8, 9, and 0. In other arrangements, the ten different integers could be assigned among the ten keys differently than just described.

Another embodiment uses an alternative to the above-described embodiment's number keys which alternative uses a shift key in conjunction with either the five just-described left keys or with the five just-described right keys.

Another embodiment uses an alternative design for the device's arithmetic-operator-display array, which design is used with an embodiment of the device which is limited to presenting addition and multiplication problems. The display array visually represents an addition symbol, a multiplication symbol or both of these symbols simultaneously. The centers of the addition symbol and the multiplication symbol share a 16-sided polygonal liquid-crystal-display segment essentially coincident with the intersection of the addition symbol and the multiplication symbol.

Another group of embodiments use technology other than liquid-crystal-display technology for the device's display, such as vacuum-fluorescent technology, light-emitting-diode technology, gas-discharge-tube technology, electrochromic technology, etc.

Another embodiment uses a separate key to designate each of the four arithmetic operations and possibly a fifth key to designate the use of all four operations in the same activity.

Another embodiment has at least one mode in which the time to respond to the questions has a per question limit, the question engine (such as the microprocessor) in this embodiment increasing the per question limit for those questions having a correct response that requires entry of more than one alphanumeric character by the user.

Another embodiment has at least one mode in which entry of an incorrect numeral in response to a problem causes the question engine to refuse to recognize subsequent numerals until a predetermined period of time elapses after the display of the next problem.

In general, fewer or more keys and switches could be used depending upon, among other things, the number of functions incorporated in the apparatus. In addition, a shift key could be used to provide multiple functions to some or the rest of the other keys, thereby reducing the number of keys without reducing the number of functions. Moreover, recessed actuators accessible with the tip of a ballpoint pen through holes in the surface of the case, like those often used to “reset” an electronic device, could be used instead of the device's four small recessed keys.

The scope of the invention should be determined by the appended claims and their legal equivalents, rather than by the examples given. It should be understood that the examples given above are illustrative only and are not to be taken as limitations on the scope of the present invention. By way of example, the various times given could readily vary by 0.2 or 0.3 seconds or more in either direction from the specified value without changing the functionality of the claimed invention.

1. An electronic learning aid for teaching arithmetic skills, comprising:
a question engine for selecting and communicating to a user a plurality of questions, one question at a time; and
a manually operable input device for use by the user to respond to the questions, said question engine having at least one mode in which the engine ceases accepting a response to a question upon the entry of an incorrect alphanumeric character, said question engine in response to the entry of an incorrect alphanumeric character displaying a subsequent question, and said question engine farther waiting for a predetermined period of time after display of the subsequent question before accepting a response to said subsequent question.

2. The electronic learning aid as set forth in claim 1 wherein the alphanumeric characters are numerals and the questions are arithmetic problems, the question engine being capable of accepting a sequence of numerals in response to a particular arithmetic problem, the question engine further being responsive to entry of an incorrect numeral in the sequence to display a subsequent arithmetic problem.

3. The electronic learning aid as set forth in claim 2 wherein the question engine delays the predetermined period of time after display of said subsequent arithmetic problem before accepting the entry of any numerals subsequent to the incorrect numeral.
